(19) United States
(12) Patent Application Publication
(10) Pub. No.: US 2009/0307070 A1
(43) Pub. Date: Dec. 10, 2009

(54) GOODS AND SERVICES-BASED TRADE METHOD AND SYSTEM

(75) Inventor: Richard Logie, Grampian (GB)

Correspondence Address: POLSINELLI SHUGHART PC, 700 W. 47TH STREET, SUITE 1000, KANSAS CITY, MO, 64112-1802, US

(73) Assignee: Krista Vard-Abash, Fairport, NY (US)

(21) Appl. No.: 12/092,502

(22) PCT Filed: Nov. 6, 2006
(86) PCT No.: PCT/US06/43330

§ 371 Date: Sep. 29, 2008

Related U.S. Application Data
(60) Provisional application No. 60/733,414, filed on Nov. 4, 2005.

(51) Int. Cl. G06Q 30/00

(52) U.S. Cl. 705/14.15; 705/26

(57) ABSTRACT

Trading methods and systems for promoting trade credit transactions between and among Trade Credit Exchanges and other users such as non-commercial consumers are described

### CROSS-REFERENCE TO RELATED APPLICATIONS

This application claims the benefit of the filing date of U.S. provisional application Ser. No. 60/733,414 entitled “Trade Method and System” which was filed on Nov. 4, 2005.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

1. Field of the Invention

The present invention relates generally to transactional management and accounting systems and methods, and more specifically to systems and methods for enabling transactions involving trades of goods and services.

2. Description of the Related Art

An estimated 600 commercial trade exchanges, also known as commercial trade exchanges, exist worldwide. A commercial Trade Credit Exchange is an individual or organization with members or clients that contract with each other (or with the trade exchange) to jointly trade property or services. Commercial Trade Credit Exchanges may or may not embrace arrangements that provide solely for the informal exchange of similar services on a noncommercial basis. Recognition and awareness of commercial Trade Credit Exchanges and the success of the commercial exchange industry have improved markedly over the past two decades in part, at least in the United States, because of the Tax Equity and Fiscal Responsibility Act (TEFRA) of 1982. TEFRA recognizes commercial Trade Credit Exchanges in the United States as third-party record keepers, similar to accountants and banks. TEFRA also requires that commercial Trade Credit Exchanges in the U.S. annually provide the Internal Revenue Service (IRS) with the trade credit income of exchange members.

However, advancement of the commercial trade exchange industry has been limited over the past several decades by the prevailing business model in which only “B2B” (business-to-business) trade credit transactions are recognized and used. Only merchants and manufacturers of goods and services are eligible for membership and participation as exchange members because only such entities supply the goods and services that back the trade credits constituting the cash-alternative currency of any Commercial or Corporate Trade Credit Exchange. The everyday consumer therefore has faced and continues to face a practical bar from participation in commercial Trade Credit Exchanges.

A number of computerized cash and credit accounting systems are known for handling transactions based on the exchange in part or whole of United States dollars or other national currency denominations. However, these existing systems do not manage transactions in which purchasers such as the everyday consumer have a form of non-cash credit to offer in exchange for goods and services.

### SUMMARY OF THE INVENTION

The present disclosure provides new methods and systems that allow consumers who do not have goods or services to offer in trade for other goods or services to nevertheless participate in commercial Trade Credit Exchange. The methods and systems permit transactions to be made primarily on a non-cash basis or completely without cash.

In one aspect, the present invention provides a method of rewarding a buyer for a purchase from a seller that is a member of a Trade Credit Exchange, the method comprising the seller offering an amount of Epoints to a buyer of goods or services from the seller, the Epoints redeemable by the buyer for non-or part cash purchase of other goods and services in a Trade Credit Exchange or network of Trade Credit Exchanges, and the seller transferring the amount of Epoints to the buyer when the buyer completes a purchase of goods or services from the seller. In one embodiment, the accounting system of the Trade Credit Exchange records trade credit transactions between buyers and sellers of the exchange, and the method further comprises issuing an amount of Epoints to the seller, the amount of Epoints based upon a cash value of goods or services offered by the seller for non-or part cash purchase through the Trade Credit Exchange, the accounting system adding the amount of Epoints to an Epoint account uniquely associated with the buyer in the Trade Credit Exchange, and the accounting system accumulating the amount of Epoints in the Epoint account having a total Epoint amount, the Epoint account uniquely associated with the buyer. The accounting system of the Trade Credit Exchange is, in one embodiment, an electronic accounting system in electronic communication with a plurality of electronic point-of-sale terminals. In one embodiment, the accounting system provides access by the buyer to Epoints in the buyer's Epoints account for use in exchange for a good or service offered for purchase through the Trade Credit Exchange. In one embodiment, access to Epoints is provided by determining that the buyer has properly accessed the buyer's Epoint account, and decreasing the total Epoint amount in the buyer's Epoint account by a purchase price amount when the buyer uses the purchase price amount of Epoints for a purchase of a good or service through a Trade Credit Exchange or at point-of-sale. The method may further include assigning to each buyer a unique identifier associated with that buyer's Epoint account, and when a buyer requests access to a buyer's Epoint account for a purchase, determining that the buyer is properly accessing the buyer's own account by requesting that the buyer input the unique identifier into a point-of-sale terminal.

In another aspect, the invention provides a method of promoting reciprocal trade transactions involving a seller that is a member of at least one Trade Credit Exchange obtaining an amount of Epoints from the loyalty exchange's Epoint account, the amount of Epoints determined by a cash value of a good or a service offered by the seller for non- or part cash purchase through the Trade Credit Exchange; at a point-of-sale of a good or a service to a buyer, obtaining from said buyer a unique identifier; at a location of said seller, determining an amount of Epoints to provide to said buyer; for each said transaction, providing to an electronic exchange accounting system the buyer's unique identifier in association with the amount of Epoints; for each said transaction, determining an amount of Epoints based on the amount of trade credits.; accumulating trade credits in an account in the accounting system that is associated with the buyer's unique identifier by adding the amount of trade credits to a total trade credit amount in the account; and providing the buyer associated with that buyer's unique identifier access to the total trade credit amount in the buyer's account for use for non- or part cash purchases through at least one Trade Credit Exchange. In one embodiment, the amount of Epoints to provide to the buyer is determined by applying a reward rule selected by the seller to the purchase amount of the transaction. In one embodiment, the reward rule comprises selecting a factor selected by the seller, and the amount of Epoints to provide to the buyer is determined by multiplying the factor by the purchase amount of the transaction. In one embodiment, the reward rule may further comprise selecting a minimum purchase price amount selected by the seller, and the amount of Epoints to provide to the buyer is determined by providing a fixed amount of Epoints to the buyer when the purchase price of the transaction meets or exceeds the minimum purchase amount selected by the seller. In one embodiment, the amount of Epoints is calculated at the point-of-sale to the buyer merchant's and electronically transmitted to the electronic exchange accounting system. In another aspect, an exchange accounting system is provided for managing transactions between buyers and multiple sellers, the system comprising: at multiple points-of-sale to buyers, an electronic data input element configured for buyers to enter an alphanumeric identifier uniquely associated with the buyer in a point-of-sale transaction, and a monetary value of the point of-sale transaction; a first electronic memory element for storing an Epoints reward rule selected by the seller to the purchase amount of the point-of-sale transaction; a first processor for calculating an amount of Epoints based upon the monetary value of the point-of-sale transaction and application of the selected Epoints reward rule; at least one location remote from the points-of-sale locations, an electronic exchange accounting system configured to receive the buyer's unique identifier and amount of Epoints for each point-of-sale transaction with the buyer; an electronic communication element configured to communicate to the electronic exchange accounting system the buyer's unique identifier and amount of Epoints for each point-of-sale transaction with the buyer; a second electronic memory element for storing accumulated loyalty points for a plurality of buyer accounts, each buyer account being associated respectively with a unique account identifier; a second processor configured to increment a total amount of Epoints in a buyer account associated with the buyer's unique identifier by the amount of Epoints associated with each point-of-sale transaction with the buyer; and an electronic access element for providing to each buyer access to the total amount of trade credits or Epoints in the buyer account associated with that buyer's unique buyer identifier and unique account identifier. In one embodiment, the second processor element is further configured to decrease the total amount of trade credits or Epoints in each buyer account according to a transaction amount of trade credits or Epoints accessed by the buyer for a transaction. In one embodiment, the electronic access element includes a printer configured for imprinting a receipt with the transaction amount of trade credits or Epoints accessed by the buyer for the trade transaction. In one embodiment the printer is further configured to imprint the receipt with information identifying a good or a service for which the buyer paid with the transaction amount of trade credits or Epoints accessed by the buyer for the trade transaction.

In another aspect, a method is provided for allowing non-commercial entities to participate in a Trade Credit Exchange, the method comprising: maintaining a Trade Credit Exchange trade credit account and a loyalty exchange Epoints account, maintaining a trade credit account and an Epoints account for each member, exchanging Epoints of Trade Credit Exchange members for goods or services offered through the Trade Credits Exchange or through a Trade Credit Exchange network; and exchanging trade credits of members for goods or services offered through the Trade Credit Exchange or through a Trade Credit Exchange network. The method may further comprise receiving Epoints from a Loyalty Exchange System.

In another aspect, a method is provided for a Trade Credit Exchange to sell goods and services, the method comprising using a Global Trade Credit Exchange System (GTCES) for maintaining a plurality of trade credit accounts and a plurality of Epoints accounts using a GTCES, and allowing members and users of the Trade Credit Exchange to purchase goods and services on the Trade Credit Exchange with trade credits or Epoints.

In another aspect, a computerized method is provided for rewarding a buyer for a purchase from a seller that is a member of a Trade Credit Exchange conducted over a computer network, comprising: the seller offering to the buyer over the computer network an amount of Epoints on the Trade Credit Exchange, the Epoints redeemable over the computer network as at least partial payment for purchase of other goods or services offered by the Trade Credit Exchange over the computer network; and the seller transferring over the amount of Epoints to the buyer when the buyer completes a purchase of goods or services from the seller,

In another aspect, a system is provided for rewarding a buyer for a purchase from a seller that is a member of a Trade Credit Exchange conducted over a computer network, the system comprising a computer device in communication with the computer network for conducting the Trade Credit Exchange, the computer device comprising: a first processing portion configured to offer an amount of Epoints to the buyer from the seller in the Trade Credit Exchange, the Epoints redeemable over the computer network as at least partial payment for purchase of goods or services offered by the Trade Credit Exchange; a second processing portion configured to receive a trade of a good or a service over the computer network from the buyer in exchange for goods or services offered by the seller; and a third processing portion configured to transfer the amount of Epoints to the buyer when the buyer completes the purchase of the seller's goods or services.

In another aspect, a system is provided for rewarding a buyer for a purchase from a seller that is a member of a Trade Credit Exchange conducted over a computer network, the system comprising: a buyer's computer in communication with the computer network; a seller's computer in communication with the computer network; and a central computer device in communication with the computer network for conducting the Trade Credit Exchange, the central computer device being communicable with the buyer's computer and the seller's computer, the central computer device comprising: a first processing portion configured to receive a listing for a good or service for sale by the seller through the seller's computer and to list the seller's good or service on the Trade Credit Exchange; a second processing portion configured to receive a trade payment for the good or service through the Trade Credit Exchange over the computer network from the buyer through the buyer's computer; a third processing portion configured to receive an amount of Epoints from the seller through the seller's computer, the Epoints redeemable on the Trade Credit Exchange over the computer network as at least partial payment for purchase of goods or services offered by the Trade Credit Exchange; and a fourth processing portion configured to direct the amount of Epoints to the buyer.

### BRIEF DESCRIPTION OF THE DRAWINGS

FIG. 1 is a schematic diagram of relationships among multiple organizational participants represented as modules in an example of a global trade credit exchange system (“GTCES”);

FIG. 2 is a schematic diagram of the multiple organizational modules in an exemplary system as shown in FIG. 1, with added detail with respect to the role of each module;

FIG. 3 is a schematic diagram of the systems as shown in FIG. 1 and exemplary inter-relationships among the participant modules and also individuals and organizations outside the systems;

FIG. 4 is a schematic diagram of a typical single location loyalty program;

FIG. 5 is a schematic diagram of a typical single location loyalty program using a cash deposit third party loyalty system;

FIG. 6 is a schematic diagram of a typical multiple location loyalty program using a cash deposit third party loyalty system;

FIG. 7 is a schematic diagram of a typical Trade Credit Exchange;

FIG. 8 is a schematic diagram depicting an exemplary relationship among direct clearing users of a GTCES system, a loyalty exchange system and a single Trade Credit Exchange;

FIG. 9 is a schematic diagram depicting an exemplary relationship among GTCES central clearing users, a loyalty exchange system and multiple Trade Credit Exchanges;

FIG. 10 is a schematic diagram depicting exemplary relationships among a GTCES, a single location loyalty exchange system and a Trade Credit Exchange;

FIG. 11 is a schematic diagram depicting exemplary relationships among a GTCES, a multi location loyalty exchange system and a Trade Credit Exchange as shown in FIG. 10, with added detail with respect to the activity of a Seller B;

FIG. 12 is a schematic diagram depicting exemplary relationships among GTCES, a multi location loyalty exchange system and a Trade Credit Exchange as shown in FIG. 11, with added detail with respect to the activity of a cash Buyer B;

FIG. 13 is a first schematic diagram depicting open trade management using a GTCES;

FIG. 14 is a second schematic diagram depicting open trade management using a GTCES;

FIG. 15 is a third schematic diagram depicting open trade management using a GTCES;

FIG. 16 is a series of eleven (11) schematic diagrams depicting alternative embodiments of a GTCES;

FIGS. 17 and 18 are schematic diagrams depicting an exemplary flow of trade credits and debits among parties using a GTCES; and

FIG. 19 is a schematic diagram depicting an exemplary relationship between various universal currency systems using a GTCES.

### DETAILED DESCRIPTION OF THE PREFERRED EMBODIMENTS

### Abbreviations and Definitions

To facilitate understanding of the invention, a number of terms and abbreviations as used herein are defined below as follows:

“Reciprocal trade”: as used herein, the term “reciprocal trade” or “trade” refers to the activity of joint trade among at least two entities, in which goods or services are traded between the entities in direct exchange for other goods or services, or are traded in indirect exchange for other goods or services through the use of trade credits

“Trade Credit Exchange” and “Commercial Trade Exchange” and “Trade Exchange”: As used interchangeably herein, the terms “Trade Credit Exchange”, “Commercial Trade Exchange” and “Trade Exchange” refer to any person or organization composed of members that contract among each other to jointly trade property such as goods or services, including any network of one or more such organizations, in which trades are conducted using non-cash credit in whole or part payment for the goods and services.

“GTCES”: As used herein, the term “GTCES” is an acronym for the term “Global Trade Credit Exchange System” which refers to a group of interconnected transactional management tools used by Trade Credit Exchanges to manage and keep account of trade credit transactions made through the Trade Credit Exchange or through a network of exchanges.

“Fiat currency”: As used herein, the term “fiat currency” refers to currency that is deemed by law, through action of a government or its central banking system, as legal tender for satisfaction of money debts, and may include paper currency not backed by fixed assets, or currency or notes issued without the promise of redemption in some other form.

“Exchange Credit” or “Exchange Trade Credit”: As used herein, the term “exchange credit” broadly refers to a trading unit used in a GTCES including trade credits and Epoints which include loyalty points and reward points.

“Trade Credit”: As used herein, the term “trade credit” refers to a unit of value of exchange as determined by a given Trade Credit Exchange which, though it does not refer directly to a national currency or legal tender, may be valued by reference to a local national currency or legal tender.

“Trade Credit Clearing”: As used herein, the term “trade credit clearing” refers to the activities of exchanging and redeeming trade credits and loyalty points between and among Trade Credit Exchanges and non-commercial users of a GTCES such as consumers.

“Trade Credit Cost”: As used herein, the term “trade credit cost” refers to a direct cash liability incurred in exchange for a trade credit, also referred to as “cost of goods sold” or “C.O.G.S.”

“Epoint”: As used herein, the term “Epoint” is a contraction of the words “exchange” and “point”, and refers to a type of exchange credit including loyalty points, reward points and rebate points, that are issued to commercial and non-commercial users by sellers upon purchases from the seller through a Trade Credit Exchange or loyalty exchange or point of purchase location.

“Loyalty Point”: As used herein, the term “loyalty point” refers to first type of Epoint issued to commercial users upon making a predetermined number of purchases through a Trade Credit Exchange.

“Loyalty Exchange”: As used herein, the term “loyalty exchange” clears and converts trade credits and Epoints for a Trade Credit Exchange and for Trade Credit Exchange members.

“Reward Point”: As used herein, the term “reward point” refers to a second type of Epoint issued to non-commercial users upon purchases and satisfying a predetermined reward rule established by the loyalty exchange or sellers in a Trade Credit Exchange.

“Prosumer”: As used herein, the term “prosumer” is a contraction of the words “producer” and “consumer” and refers broadly to a consumer who decides to sell goods or services into an economy. A prosumer is therefore not strictly a consumer, and not strictly a buyer or a seller.

“Consumer”: As used herein, the term “consumer” refers to any person or organization that buys a product or service for personal use.

“User”: As used herein, the term “user” refers broadly to an individual or organization that participates as a buyer or a seller or otherwise in a GTCES through any activity that produces or transfers exchange credits such as loyalty points or trade credits in a GTCES.

“Seller”: As used herein the term “seller” refers broadly to an individual or organization that offers a good or a service for sale, including a commercial vendor as well as a non-commercial individual or organization that offers one or a very limited number of items or services for sale.

“Buyer”: As used herein the term “buyer” refers broadly to an individual or organization that purchases a good or a service for sale.

“Open Trading”: As used herein the term “open trading” refers to the activity of at least two Trade Credit Exchanges in which each exchange allows members of the other exchange(s) to obtain information from its exchange and to trade with its members through an interconnected transactional management system.

As used interchangeably herein, the terms “CCS's”“Community Credit Systems”, “Complementary Currency Systems” “Community Credit Organization”, and “Complementary Credit Systems” refer to non-commercial, community based, mutual credit systems utilizing a non-cash credit to facilitate transactions between members similar to commercial Trade Credit Exchanges except without any (or with very minimal) transaction and membership fees. CCSs are typically not for profit cooperative arrangements, usually unincorporated and operated by volunteers. LETS is an example of a global model of a CCO, an example of which can be found at: http://letslinkuk.org/.

In the commercial Trade Credit Exchange economy, a trade credit is a unit of monetary accounting that may be linked to a national fiat currency (for example, a “Trade Dollar”, a “Trade Euro”, etc.), or not, and is the trading currency used by Trade Credit Exchange organizations world-wide. The trade credit is the means by which the value of a sale is transferred from a buyer's account to a seller's account in a Trade Credit Exchange organization. For example, in a given trade exchange, a first member of the exchange offers a good or service A for sale through the trade exchange. Typically, a money value of the offering A is made according to local market factors, a money value associated with A, and a corresponding trade credit value associated. If, for example, the Trade Credit Exchange deals in trade credits linked to the US national fiat currency, the US dollar, then the trade credit value of A is typically the same or close to the dollar value of A. In a traditional Trade Credit Exchange, potential buyers are commercial members of the Trade Credit Exchange, or of a larger exchange network encompassing the Trade Credit Exchange, who have accrued or are eligible to accrue trade credits by making their own offers for sale of goods or services through the Trade Credit Exchange or network. One member acting as buyer purchases a good or service A from another member acting as seller by paying the purchase price amount in trade credits or trade dollars to the seller.

In the regular retail economy, a loyalty card or rewards card is typically a plastic or paperboard card, visually similar to a credit card or debit card that identifies the cardholder as a member in a buyers' incentive program. The cards are referred to differently in different markets. In the United Kingdom such a card is typically called a loyalty card, in Canada usually a rewards card or a point's card, and in the US a discount card, a club card or a rewards card. The card may also take the form of a smaller key ring tag often used for greater convenience. A retail establishment or a retail group typically issues a loyalty card to consumers who then use it as a form of identification when making purchases with that retailer.

Loyalty cards typically involve the card issuer requesting or requiring customers seeking such a loyalty card to provide an amount, usually minimal, of identifying or demographic data, such as name and address. The cards typically have a barcode or magnetic strip encoding the information that can be easily electronically scanned, and some include microchips containing identifying information of the cardholder. The consumer presents the card at the point of sale (POS), and the consumer's information is noted, typically electronically, and associated with details of the purchase such as identification of the good or service purchased, the monetary value of the purchase, and other details such as the date, retail location, and the like. By presenting the card, the purchaser is typically entitled to either a discount on the current purchase, or an allotment of some units or markers such as points that are then used to determine a reward to the purchaser such as credit or discount toward future purchases with the same retailer.

Application forms for the cards usually entail agreements by the store concerning customer privacy, typically non-disclosure (by the store) of non-aggregate data about customers. The retailer uses aggregate data internally (and sometimes externally) as part of its marketing research. Where a customer has provided sufficient identifying information, the loyalty card may also be used to access such information to expedite verification during receipt of checks or dispensing of medical prescription preparations, or for other membership privileges (e.g., access to a club lounge in airports, using a frequent flyer card).

In a GTCES as described herein, prosumers and consumers acquire loyalty points and reward points, herein referred to collectively as Epoints and previously only associated with loyalty card arrangements, as trade credits. Epoints are therefore, within a GTCES, a trade credit unit available to non-commercial entities such as a typical consumer. Whereas only a Trade Credit Exchange and Commercial Trade Credit Exchange members have previously been eligible to deal directly in trade credits within the Trade Credit Exchange, a GTCES makes consumers eligible to deal in the Trade Credit Exchange using Epoints. For example, a commercial member of a Trade Credit Exchange sells goods or services through the Trade Credit Exchange for an amount of trade credits, and then uses an amount of trade credits to purchase an amount of Epoints. The Epoints are then made available to the commercial member for issue to commercial and non-commercial users of GTCES when they make purchases from the commercial member through the Trade Credit Exchange or network of Trade Credit Exchanges or at a point-of-sale (merchants' stores). The GTCES therefore significantly changes the model for transacting business through commercial Trade Credit Exchange because the GTCES introduces the everyday consumers into the current B2B model by putting the Trade Credit Exchange's trade credit in the hands of consumers through the loyalty/reward-type process. This presents new opportunities for the Trade Credit Exchange, for commercial members of Trade Credit Exchanges around the world, and for everyday consumers who are now able to obtain various goods and services via a trade credit, thereby avoiding the use of cash. The Trade Credit Exchange experiences increased volume of business in the form of increased number of transactions. Additionally, the GTCES is configured to provide a bridge between other non-profit, non-commercial, locally run, community currencies (“complementary currencies”) that have a need to expand product and service offerings to their users, who are typically community-minded, locally focused businesses.

A GTCES is distinguished from known Loyalty/Reward networks including both single location and multi location systems that work on a cash deposit/cash liability basis, as described in further detail infra. Typically, businesses that desire to implement a loyalty or reward program do so by issuing credits to customers as reward for their purchases. Third party loyalty companies are currently the outlet for such credits. Businesses desiring to implement a consumer loyalty program contract with a third-party loyalty company, and must back each credit (or “reward point”, “loyalty point, or “buck”, etc.) with cash. Small and even medium-sized businesses frequently cannot afford to implement the programs because the required cash outlay is prohibitive and the unused points known as “breakage” cannot be recovered. Additionally, small to mid-size businesses face problems when the customer wants to redeem issued points because a smaller volume of business is often associated with smaller inventories, lack of choices, etc. For example, a customer buying tools in a hardware store that is offered membership in a reward program but informed she can only use the points towards purchases of hardware store inventory, very likely will decline. In contrast, a GTCES ties in a loyalty and reward program with the commercial Trade Credit Exchange and networks thereof, so that commercial members of a Trade Credit Exchange such as businesses and individual merchants, even smaller ones, are then able to implement a loyalty and reward program by obtaining loyalty points that they will award to consumers by backing the points with the sale of goods and or services through the Trade Credit Exchange. By using the Trade Credit Exchange network, the consumer has a diverse local and global inventory of goods and services for which their Epoints can be redeemed.

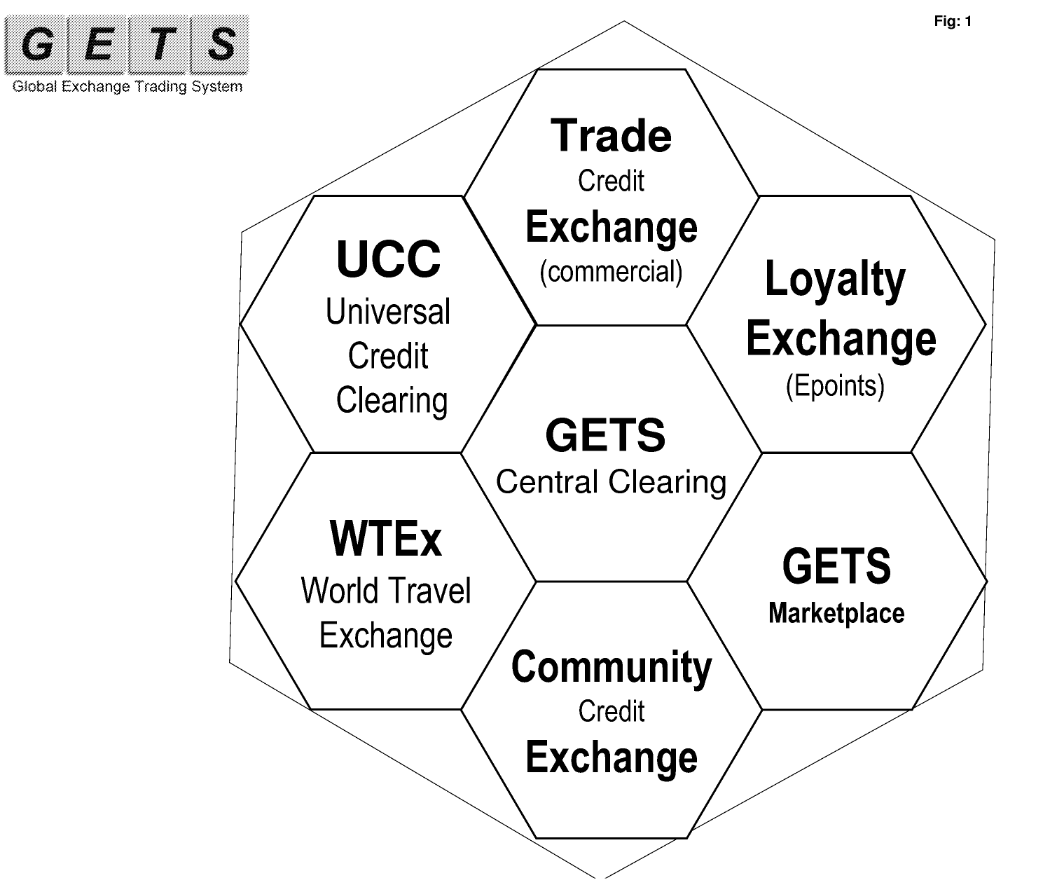

Referring to the Figures, the term “Global Exchange Trading System” (“GETS”) refers to one example of a GTCES as described herein. FIG. 1 is a schematic diagram of multiple organizational modules that may participate in a GTCES, including minimally a commercial Trade Credit Exchange or a community credit system or complementary currency system (e.g. a “CCS”). The GTCES optionally also encompasses a Loyalty Exchange, a GTCES (GETS) Marketplace, a World Travel Exchange, and a Universal Credit Clearing system.

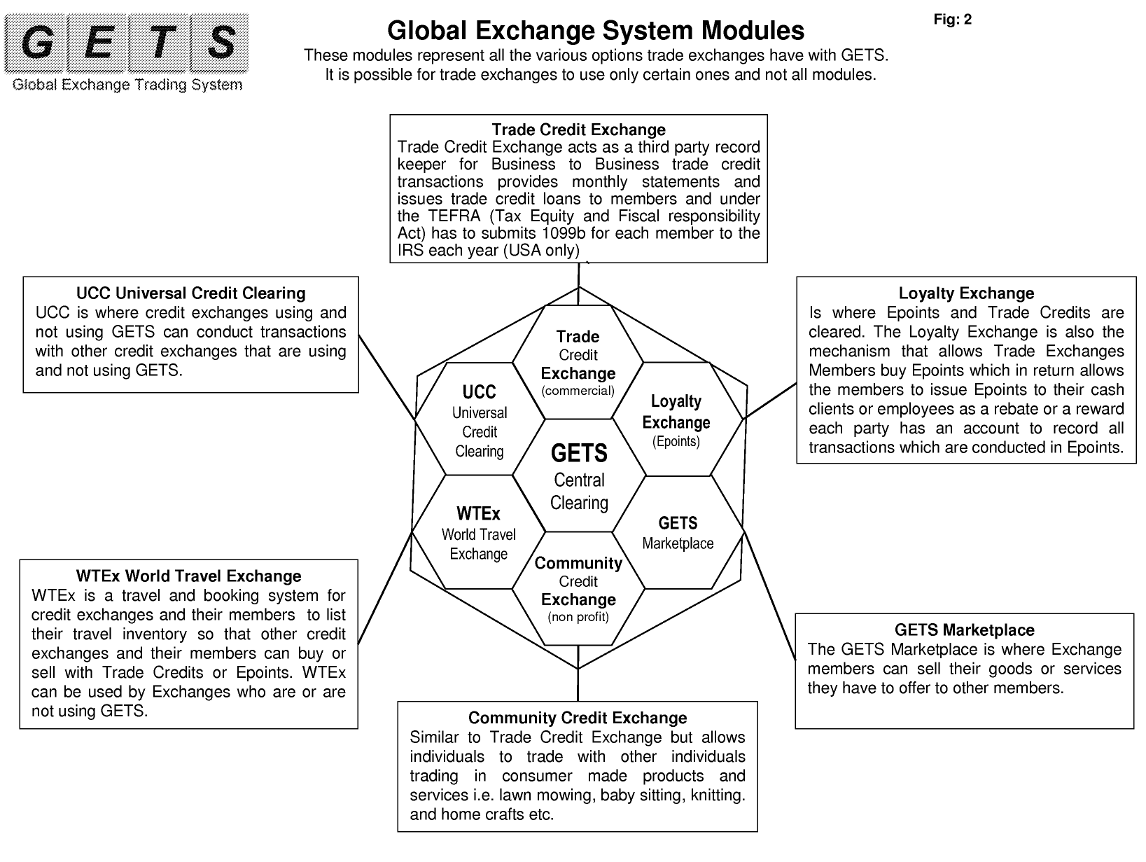

FIG. 2 sets forth the modules with further detail. The Trade Credit Exchange includes member clients and administration. In a GTCES, in contrast to other Trade Credit Exchanges, members include commercial members of the exchange and also consumers and prosumers who may or may not make sales offers through the Trade Credit Exchange, but make non-cash or part-cash purchases through the Trade Credit Exchange Administration in the Trade Credit Exchange provides record-keeping and reporting functions for the Trade Credit Exchange, recording all transactions and issuing regular sales and account statements to members. An exemplary such Trade Credit Exchange is an electronically managed trade exchange known as TBEx, “The Business Exchange” as provided in further detail on-line at www.tbex.com. The Loyalty Exchange, by arrangement and communication with the Trade Credit Exchange, issues Epoints to Trade Credit Exchange members as purchase incentives to potential buyers. The GTCES marketplace, by arrangement and communication with the Trade Credit Exchange and the Loyalty Exchange, is a sales outlet for goods and services traded to back Epoints purchased by Trade Credit Exchange members. Such goods and services may be purchased from the GTCES marketplace using cash, trade credits or Epoints.

The CCS is similar to the Trade Credit Exchange but is configured to provide Trade Credit Exchange services to members not trading for profit. Typically, the administrative functions including record-keeping and reporting are either disabled or significantly reduced, but the CCS may operate exactly like the Trade Credit Exchange, with merely a difference in membership fees and demographics.

The World Travel Exchange is a travel search and booking system that, in association and communication with the Trade Credit Exchange, provides the necessary information and services for the Trade Credit Exchange to search for and list travel options for members of the Trade Credit Exchange, or of the CCS. In a GTCES, travel options as communicated by the World Travel Exchange are purchased with cash, Trade Credits or Epoints. An exemplary such travel exchange is WTEx, an on-line system currently owned and operated by GTCES that is a travel inventory site used by Trade Credit Exchanges around the world. Further details are also available on-line at www.wtex.orggets.org.

The GTCES also optionally incorporates a universal credit clearing system, which is an electronically implemented exchange system that permits trade credit exchange-to-trade credit exchange transactions across markets using different trade credits. More specifically, a universal credit clearing system and process facilitates and accounts for global reciprocal trading of goods and services between Trade Credit Exchanges using a common unit of trade credit value. In a GTCES, a universal credit clearing system also allows access to GTCES services and features to Trade Credit Exchanges that have not implemented a GTCES. Such a process is known and currently used by Trade Credit Exchanges across the globe. One such system is wholly owned and operated by the International Reciprocal Trade Association (“IRTA”), which are a trade association representing the commercial and corporate trade exchange industry and its members. More details on IRTA and its Universal Currency can be found at www.irta.coin and www.ucci.biz.

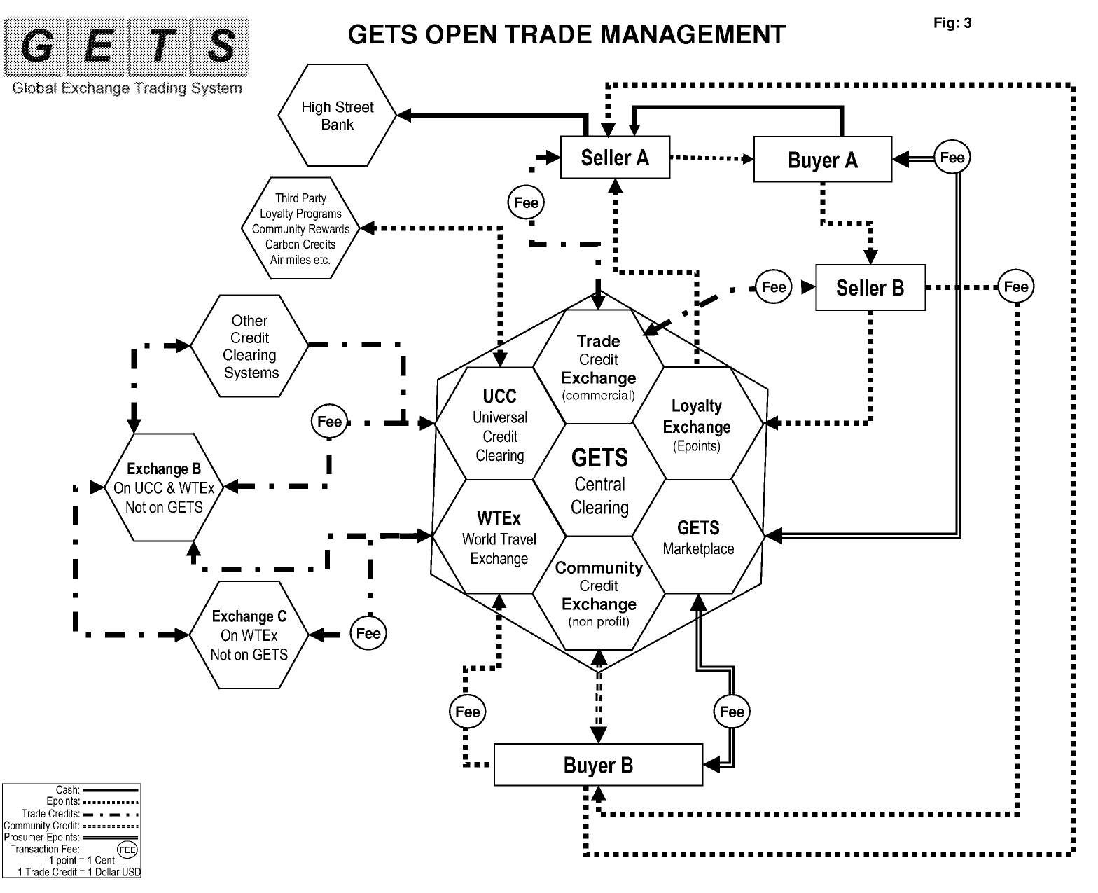

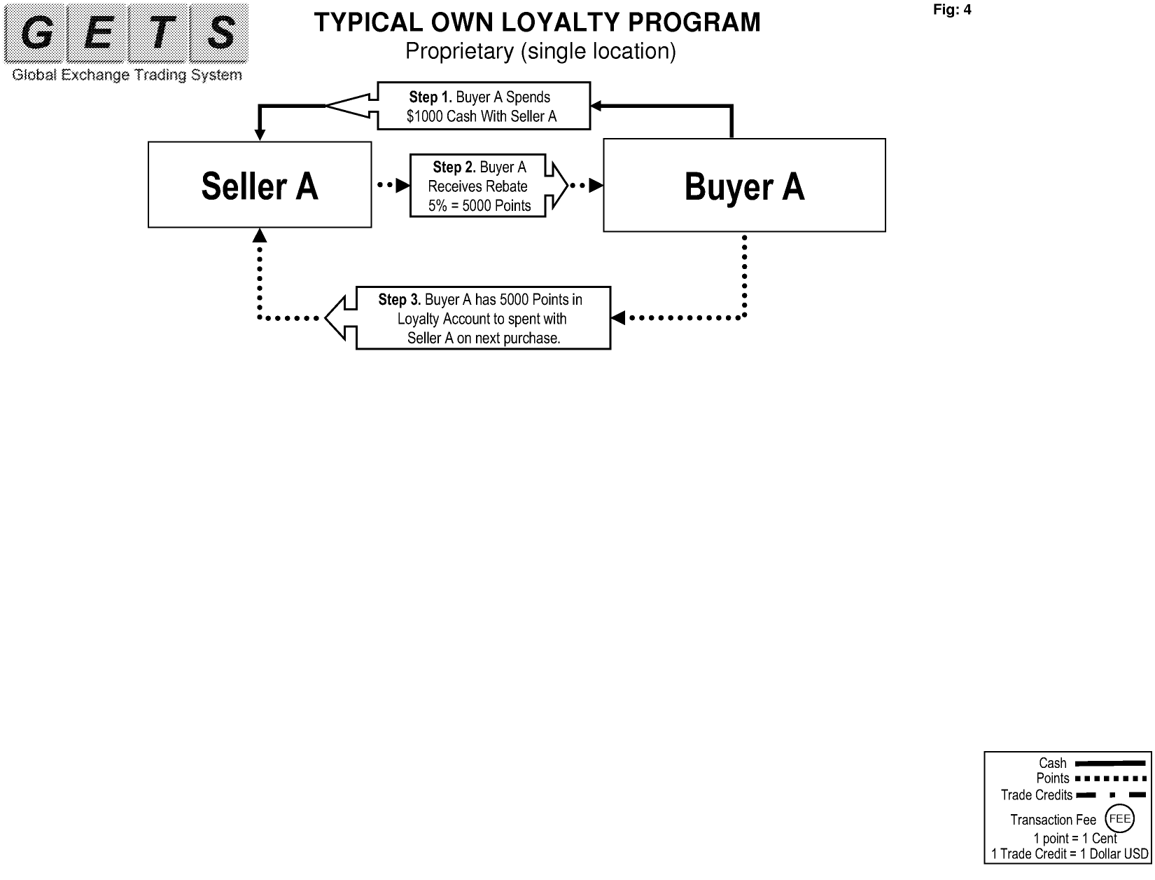

FIG. 3 is a schematic diagram of the exemplary GTCES as shown in FIG. 1 and the process of open trade management using GTCES. Arrows indicate exemplary flow of cash, trade credits, and Epoints. Circles indicate transaction fees incurred in the system. Cash flow is minimal, and trading is primarily accomplished using trade credits and Epoints. For example, a Seller A sells goods or services through Exchange A, and in return for that sale and a transaction fee, receives an amount of trade credits. Seller A then purchases from the Loyalty Exchange an amount of Epoints for an amount of trade credits. Buyer A makes a cash purchase from Seller A, and Seller A rewards Buyer A for the purchase using Epoints. Buyer A then uses Epoints towards a purchase from Seller B. Buyer A is also able to make a deposit of a good or service with the GTCES Marketplace and for a fee receives trade credits. Seller B also makes a deposit of a good or service with Exchange A, pays a transaction fee to Exchange A, and receives an amount of trade credits. Seller B exchanges an amount of trade credits for an amount of Epoints from the Loyalty Exchange.

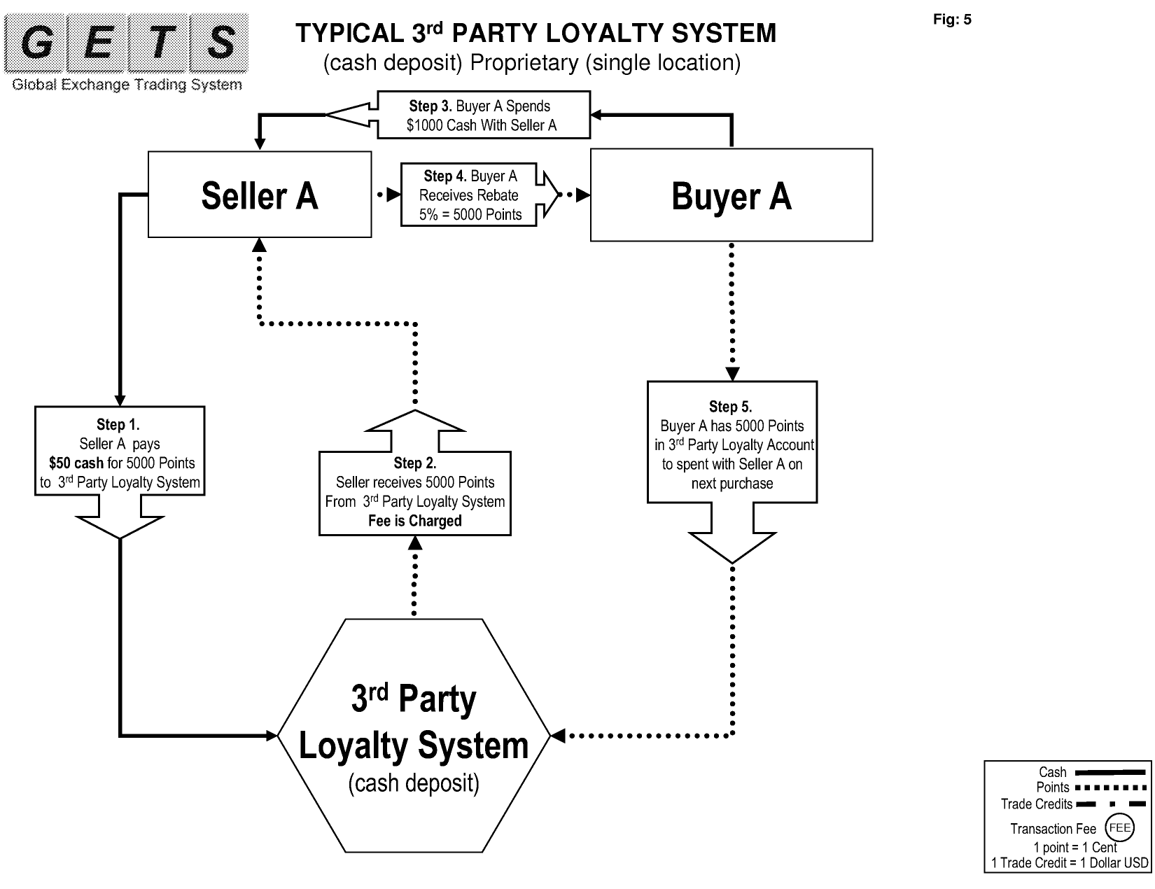

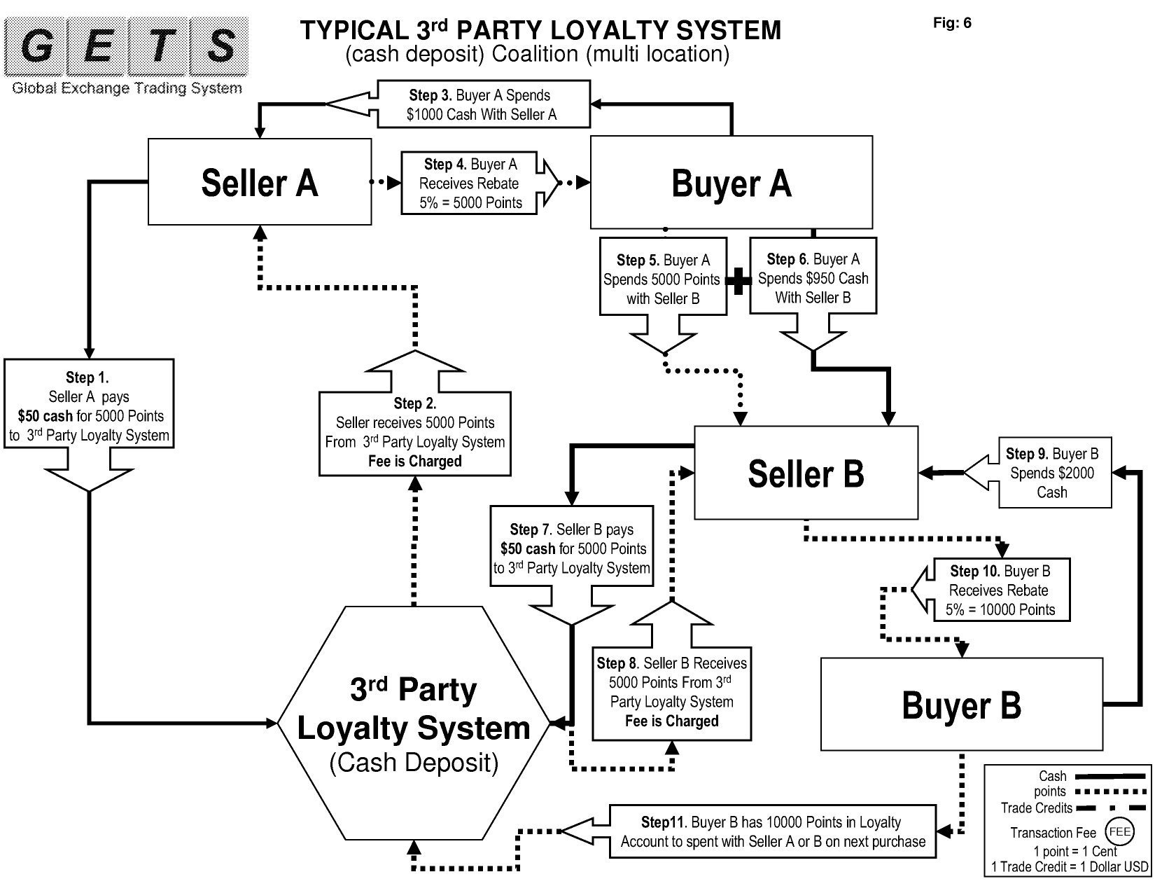

As an aid for comparison, FIGS. 5 and 6 are schematic diagrams of typical third party loyalty program systems. FIG. 5 shows a typical single location third party loyalty system in which Seller A pays an amount of cash, for example $50.00, along with a transaction fee, in exchange for an amount of loyalty points, for example 5,000 points, issued by the Third Party Loyalty System. Buyer A, upon spending $1,000 cash on a purchase or purchases from Seller A, is rewarded with a 5% rebate in the form of 5,000 points. Buyer A then has 5,000 points in a Loyalty Account which are available to spend on next purchase from Seller A. FIG. 6 is a schematic diagram of a typical third party multiple location loyalty system. As in the single location system, Seller A pays $50.00 and a transaction fee for 5,000 loyalty points from the Third Party Loyalty System, and Buyer A receives a 5% rebate for spending $1000 cash on a purchase or purchases from Seller A, as 5,000 points. Departing now from the single location system, Buyer A then spends $950 cash plus 5,000 points with Seller B. Seller B pays $50.00 cash and a transaction fee for 5,000 loyalty points from the Third Party Loyalty System. Buyer B spends $2,000 cash on a purchase or purchases from Seller B. Buyer B receives a 5% rebate for spending the $2,000 cash with Seller B, as 10,000 points. Buyer B now has 10,000 points in a Loyalty Account available to spend on a next purchase with Seller A or Seller B.

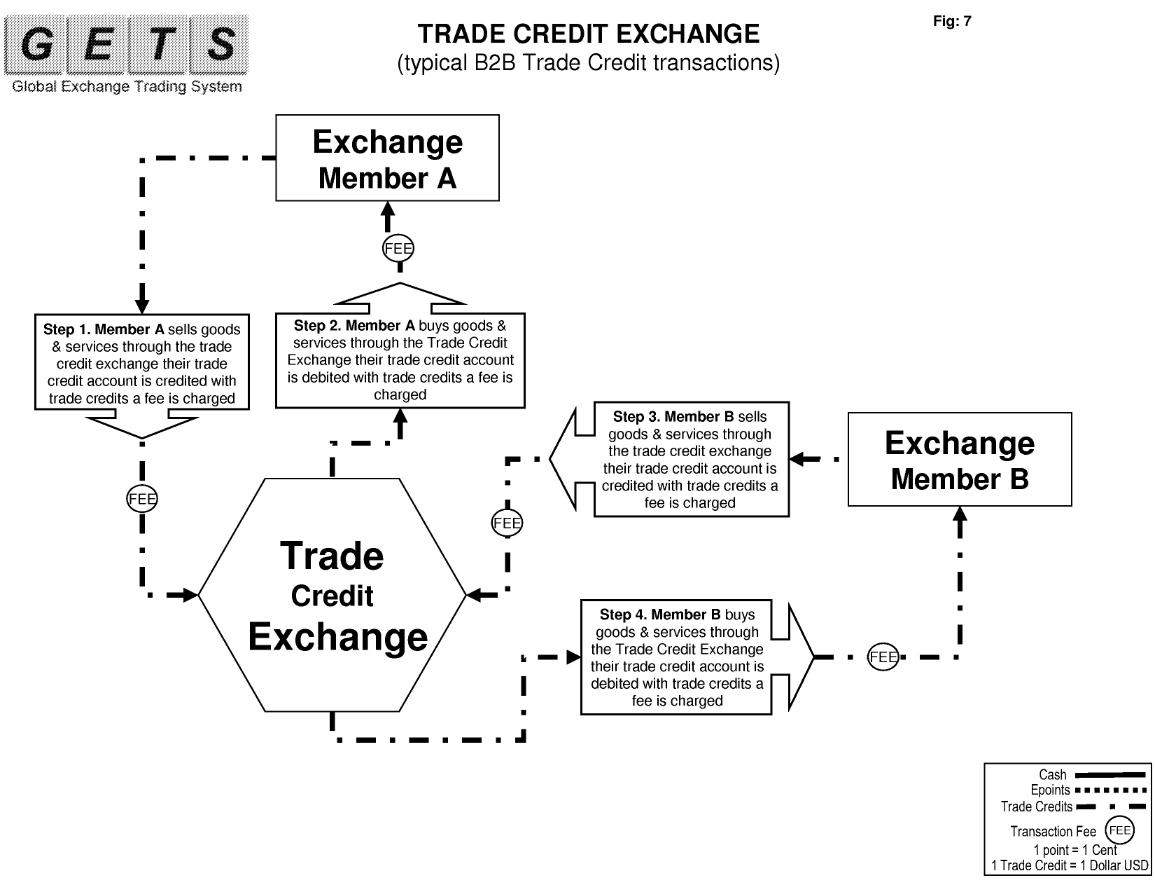

Also as an aid for comparison, FIG. 7 is a schematic diagram of a typical Trade Credit Exchange. Seller and Exchange Member A sells goods (or a service) through the Trade Credit Exchange for an amount of trade credits, and a transaction fee is charged to the Seller/Exchange Member A. Seller/Exchange Member B then purchases the goods from through Trade Credit Exchange using trade credits, and a transaction fee is charged to Seller/Exchange Member B. Seller/Exchange Member B also can sell goods (or a service) through the Trade Credit Exchange for an amount of trade credits and a transaction fee.

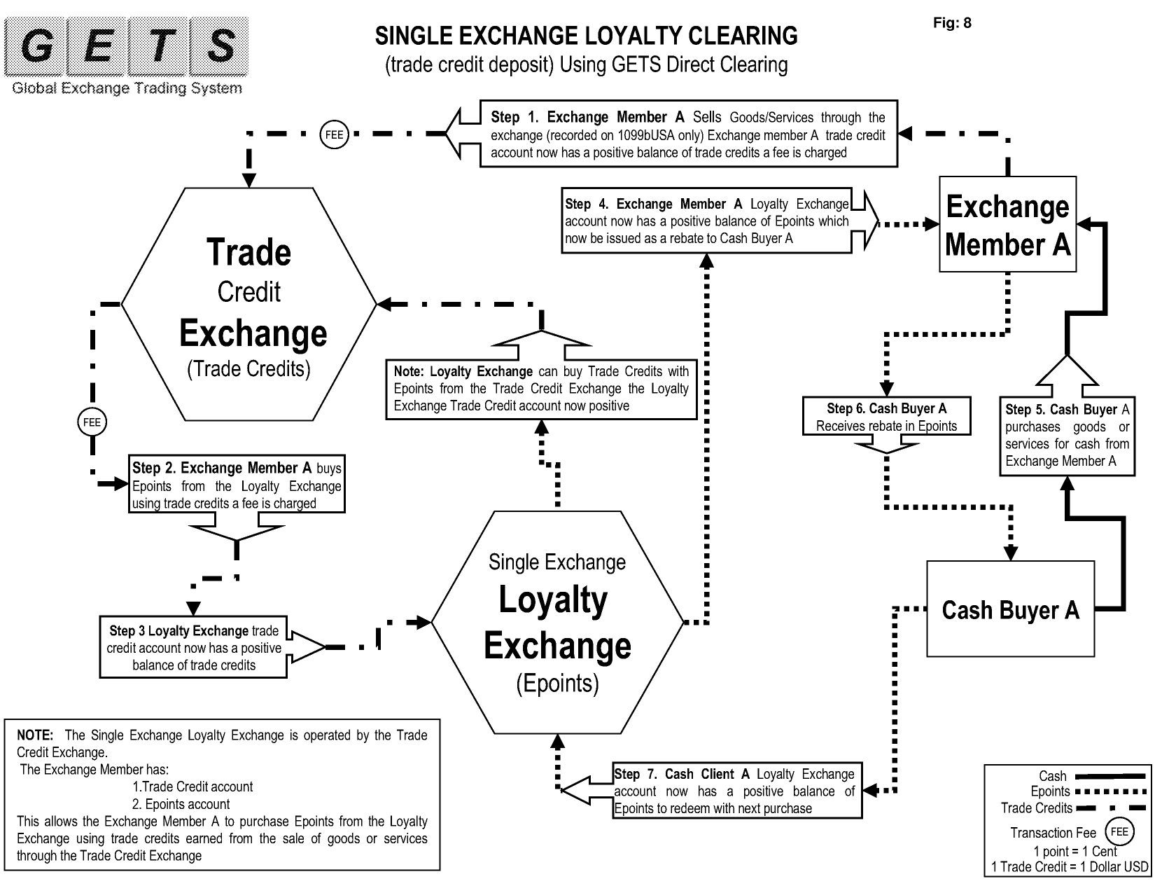

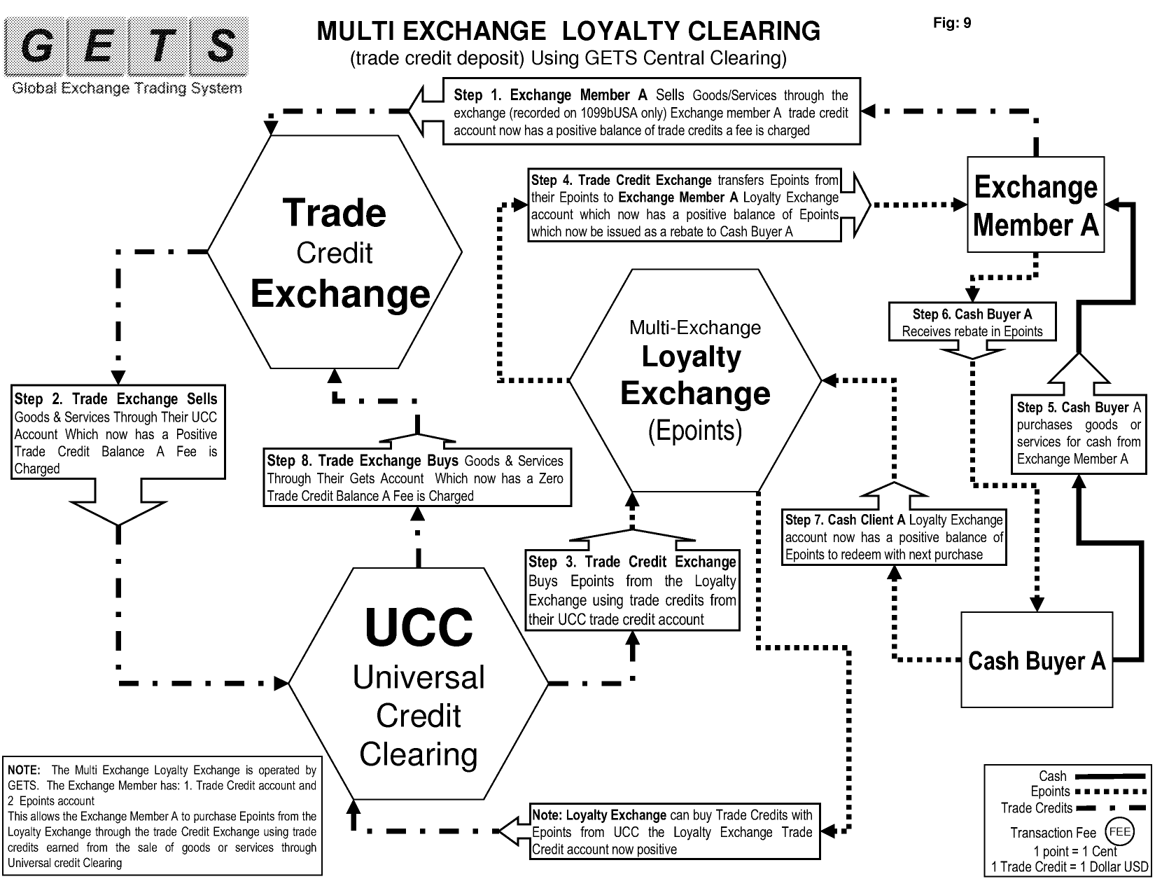

In contrast, FIGS. 8 and 9 are schematic diagrams depicting how a GTCES integrates a Trade Credit Exchange and a loyalty exchange to produce previously unrecognized and significant benefits to Trade Credit Exchange members and consumers. The direct and central clearing system aspects of the GTCES handles both trade credits and Epoints. For example, a Trade Credit Exchange using a GTCES maintains two classes of accounts, one for trade credits and one for Epoints. The GTCES clears Epoints and trade credits between the two classes of accounts.

In an exemplary embodiment, a GTCES is implemented by a Trade Credit Exchange using electronic communications and networked computers. An exemplary system for implementing the GTCES includes an electronic data input element which is a device such as a number keypad or the like, located at multiple points-of-sale to buyers. The electronic data input element is configured for a buyer to enter various types of information relating to the sale or transaction, including, for example: an alphanumeric identifier such as a Personal Identification Number (PIN) or the like that is uniquely associated with the buyer, and a monetary value of the transaction. The electronic data input element is optionally configured to receive additional information to identify the Trade Credit Exchange and the transaction. The system also includes a first electronic memory element such as a computer memory for storing the logic of a loyalty points reward rule. The loyalty points reward rule is a rule selected by the seller and applied to the monetary value of the transaction for the seller to determine an amount of Epoints to provide to the buyer. The system also includes a first processor, for example a computer processor, for calculating the amount of loyalty points based upon the monetary value of the transaction and application of the selected loyalty points reward rule. The system also includes, at one or more locations remote from the points-of-sale locations, an electronic accounting system configured to receive the buyer's unique identifier and the amount of loyalty points for each point-of-sale transaction with the buyer. The system also includes an electronic communication element configured to communicate to the electronic accounting system the buyer's unique identifier and amount of loyalty points for each point-of-sale transaction with the buyer, a second electronic memory element such as a computer memory, for storing accumulated loyalty points for a plurality of buyer accounts, wherein each buyer account is associated respectively with a unique account identifier, a second processor configured to increment a total amount of trade credits in a buyer account associated with the buyer's unique identifier by the amount of loyalty points associated with each point-of-sale transaction with the buyer; and an electronic access element for providing to each buyer access to the total amount of trade credits in the buyer account associated with that buyer's unique buyer identifier and unique account identifier.

The Trade Credit Exchange accounting system is typically configured, for example at the second processor element, to decrease the total amount of trade credits in each buyer account for according to a transaction amount of trade credits accessed by the buyer for a trade transaction. The electronic access element optionally includes a printer or other output device configured for imprinting or otherwise displaying or producing a receipt for the transaction. The receipt includes information such as the transaction amount of trade credits used by the buyer for the trade transaction, and information identifying the goods or services purchased by the buyer using trade credits or Epoints.

The GTCES therefore provides a computerized method for rewarding the buyer for a purchase from a seller that is a member of a Trade Credit Exchange that is conducted over a computer network. For example, through the seller's connection to the computer network such as through the seller's computer connected to the network, the seller's offers to the buyer an amount of Epoints on the Trade Credit Exchange. The Epoints as described herein are redeemable over the computer network as at least partial payment for the buyer's purchase of other goods or services offered by the Trade Credit Exchange over the computer network. Once the buyer has completed the purchase of goods or services from the seller on the Trade Credit Exchange, for example using the buyer's own computer that is connected to the computer network, the seller transfers the amount of Epoints to the buyer.

GTCES also encompasses a system for the seller to reward the buyer when the Trade Credit Exchange is conducted over a computer network. The system encompasses the seller's computer device in communication with the computer network that conducts the Trade Credit Exchange. The computer device includes a first processing portion configured to offer to the buyer the amount of Epoints determined by the seller. As explained, the Epoints are redeemable by the buyer for at least partial payment for purchase of goods or services offered by the Trade Credit Exchange. The computer device further includes a second processing portion configured to receive a trade of a good or a service over the computer network from the buyer in exchange for goods or services offered by the seller, and a third processing portion configured to transfer the amount of Epoints to the buyer when the buyer completes the purchase of the seller's goods or services.

In another aspect, the GTCES also encompasses a computer network system involving the buyer's computer, the seller's computer, and a central computer, wherein each computer is connected to a computer network that conducts the Trade Credit Exchange and the central computer is configured to be communicable with the buyer's computer and the seller's computer. For example, the central computer device comprises a first processing portion configured to receive a listing for a good or service for sale by the seller through the seller's computer and to list the seller's good or service on the Trade Credit Exchange, a second processing portion configured to receive a trade payment for the good or service through the Trade Credit Exchange over the computer network from the buyer through the buyer's computer, a third processing portion configured to receive an amount of Epoints from the seller through the seller's computer, the Epoints redeemable on the Trade Credit Exchange over the computer network as at least partial payment for purchase of goods or services offered by the Trade Credit Exchange, and a fourth processing portion configured to direct the amount of Epoints to the buyer.

Referring to FIGS. 8 and 9, the GTCES provides a direct and central clearing function for a Trade Credit Exchange desiring to use both trade credits and Epoints, and thereby integrates the activity of a Trade Credit Exchange with that of a loyalty exchange. The Trade Credit Exchange maintains a GTCES central clearing trade credit account, a Trade Credit Exchange trade credit account and a Loyalty Exchange Epoint account. The individual Trade Credit Exchange member wishing to issue reward points to consumers maintains a Trade Credit Exchange trade credit account and a Loyalty Exchange Epoint account. A Seller/Trade Credit Exchange member makes available for sale goods or services through the Trade Credit Exchange for an amount of trade credits, and is charged a transaction fee, with trade credits deposited to the Seller's Trade Credit Exchange trade credit account. The Trade Credit Exchange offers for sale goods and services so acquired from its member network using the Trade Credit Exchange trade credit account or a GTCES central clearing trade credit account, acquiring a balance of trade credits in the Trade Credit Exchange trade credit account or the GTCES central clearing trade credit account. In one embodiment, the Trade Credit Exchange charges a transaction fee for transactions using any GTCES account. The Trade Credit Exchange at any one time can have positive balances in both their GTCES central clearing trade credit account and their Loyalty Exchange Epoints account. They could also have a negative GTCES trade credit account balance. The Trade Credit Exchange or its members purchase Epoints from the Loyalty Exchange using the Trade Credit Exchange GTCES direct or central clearing trade credit account. The Loyalty Exchange deposits Epoints directly to the Trade Credit Exchange or its members Epoints account. The Trade Credit Exchange deposits Epoints to the Trade Credit Exchange member's Loyalty Exchange Epoints account. The Trade Credit Exchange member can then issue Epoints to consumers via aforementioned method. The Trade Credit Exchange is able to purchase goods and services through its GTCES trade credit account. Optionally, the operator of GTCES charges the Trade Credit Exchange a transaction fee.

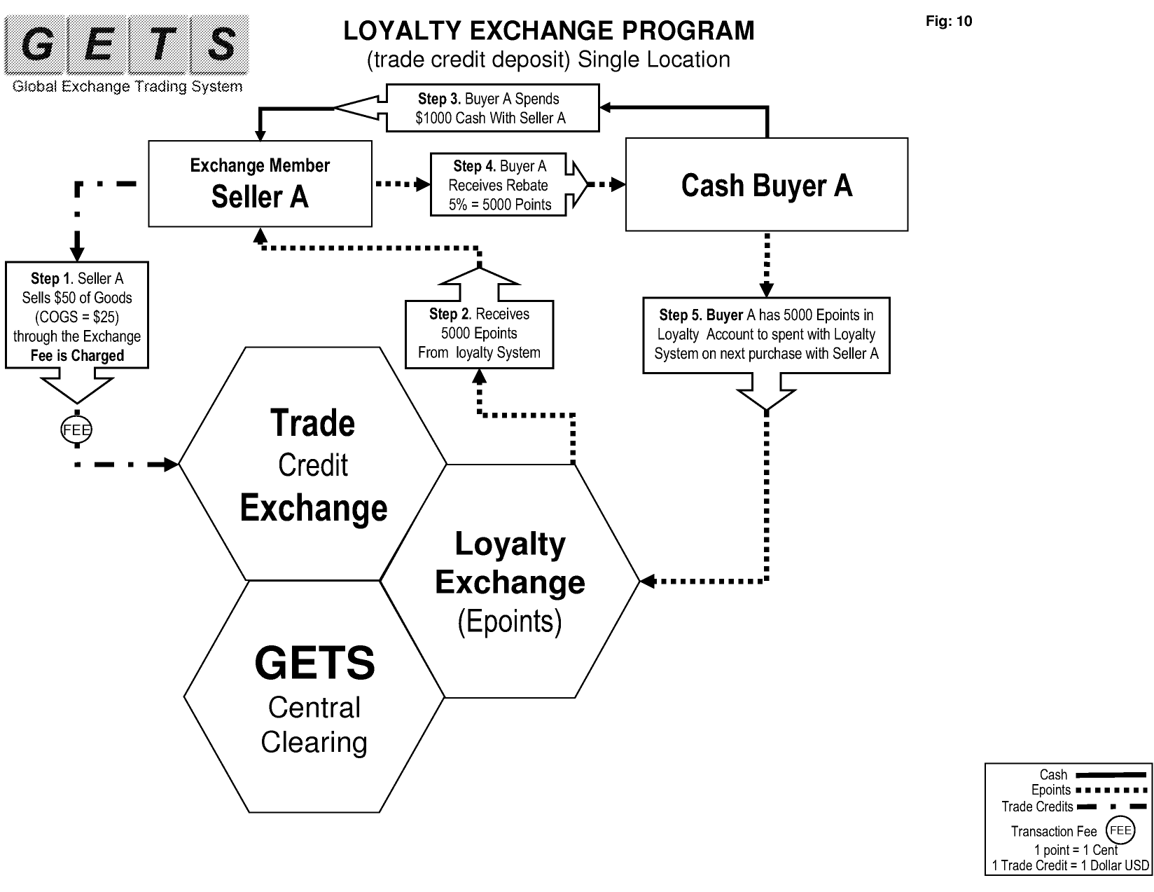

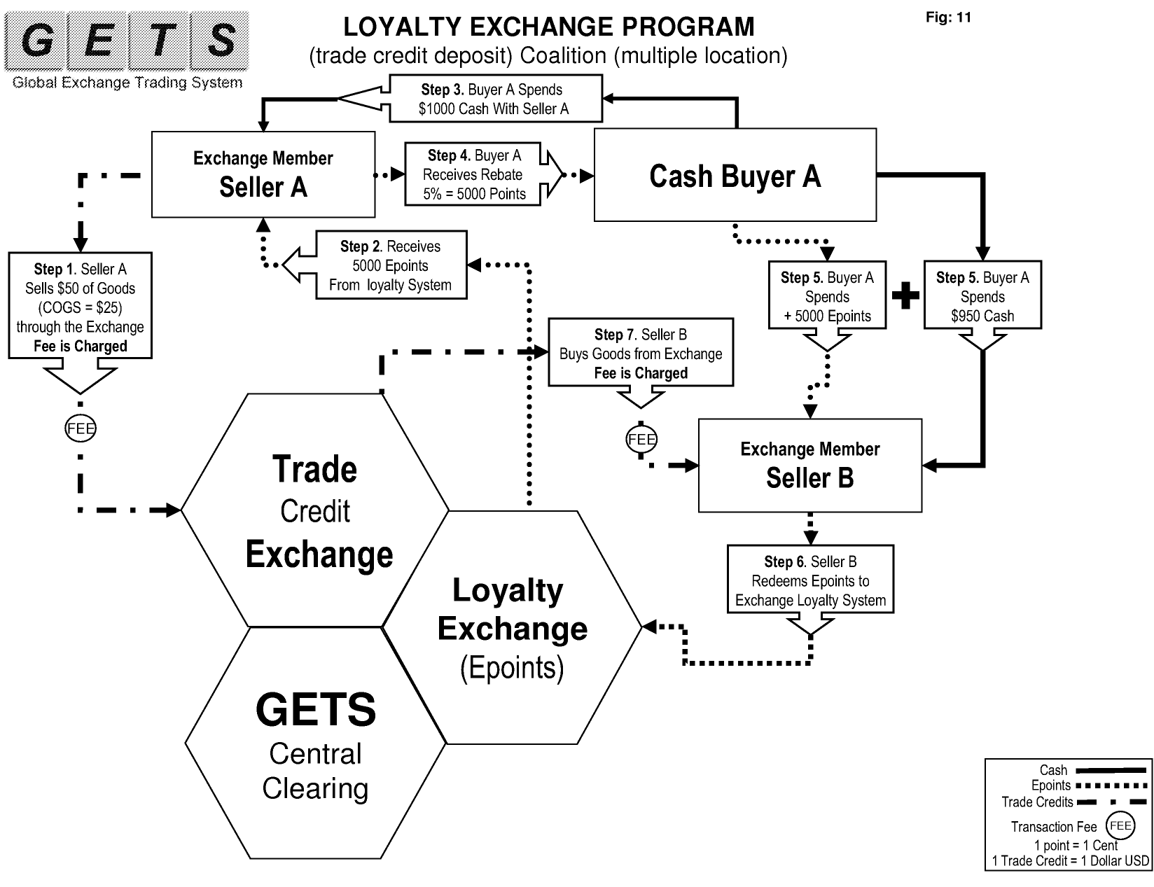

FIGS. 10 and 11 illustrate more specifically how a GTCES integrates Trade Credit Exchange activity with respectively, a single location loyalty exchange system and a multi location loyalty exchange system.

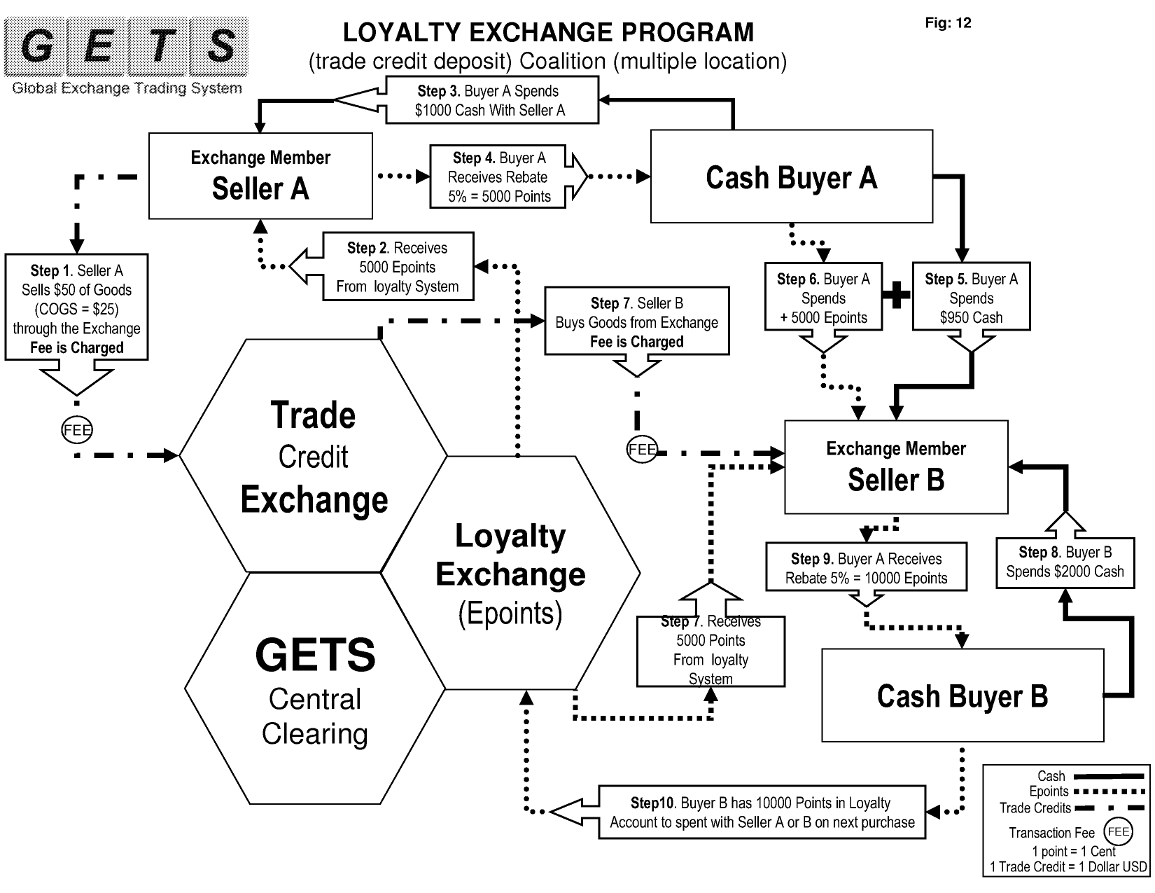

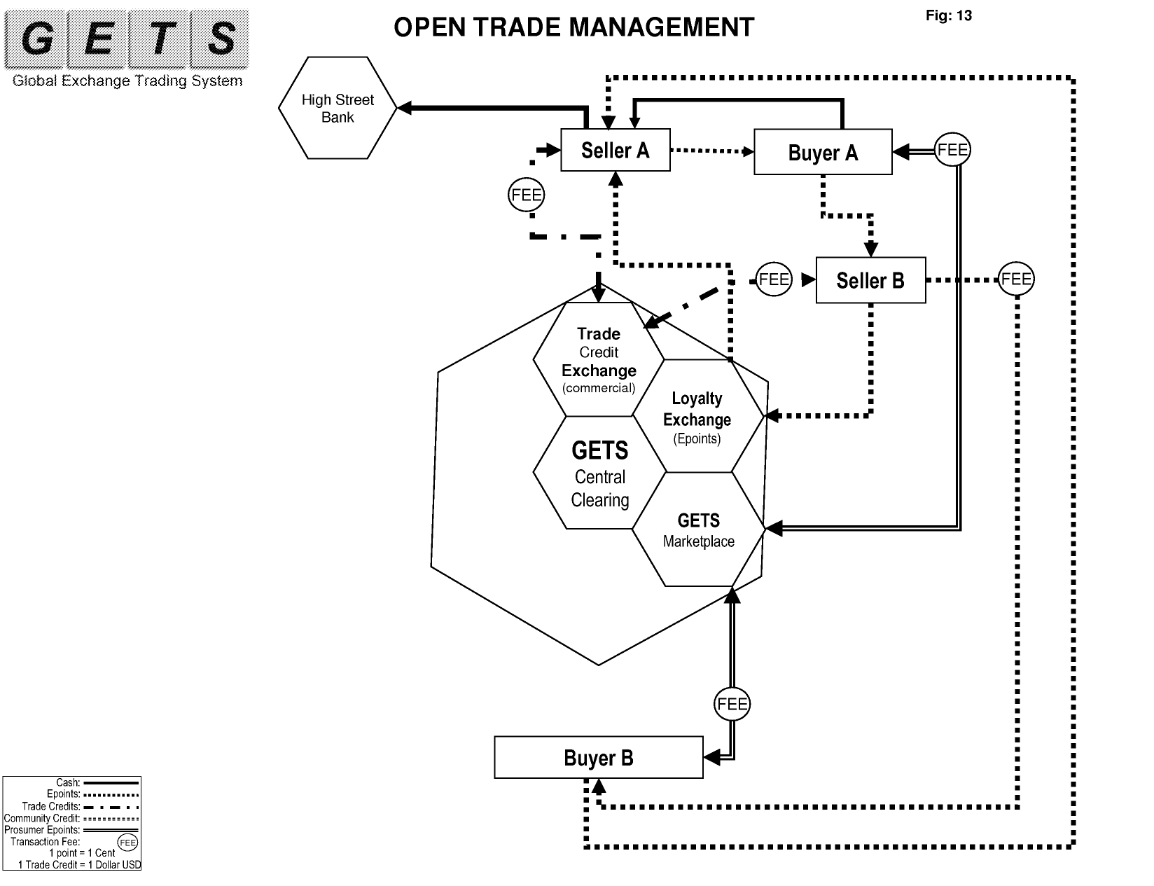

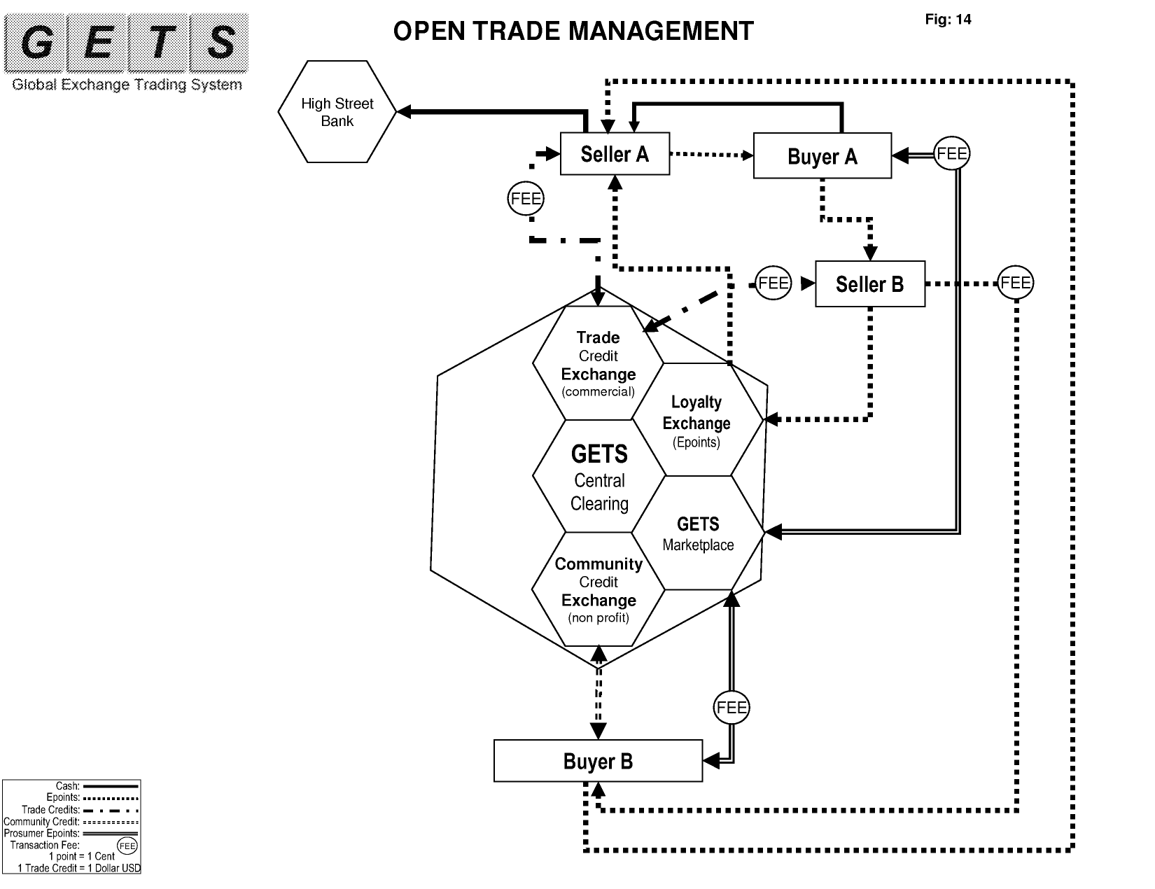

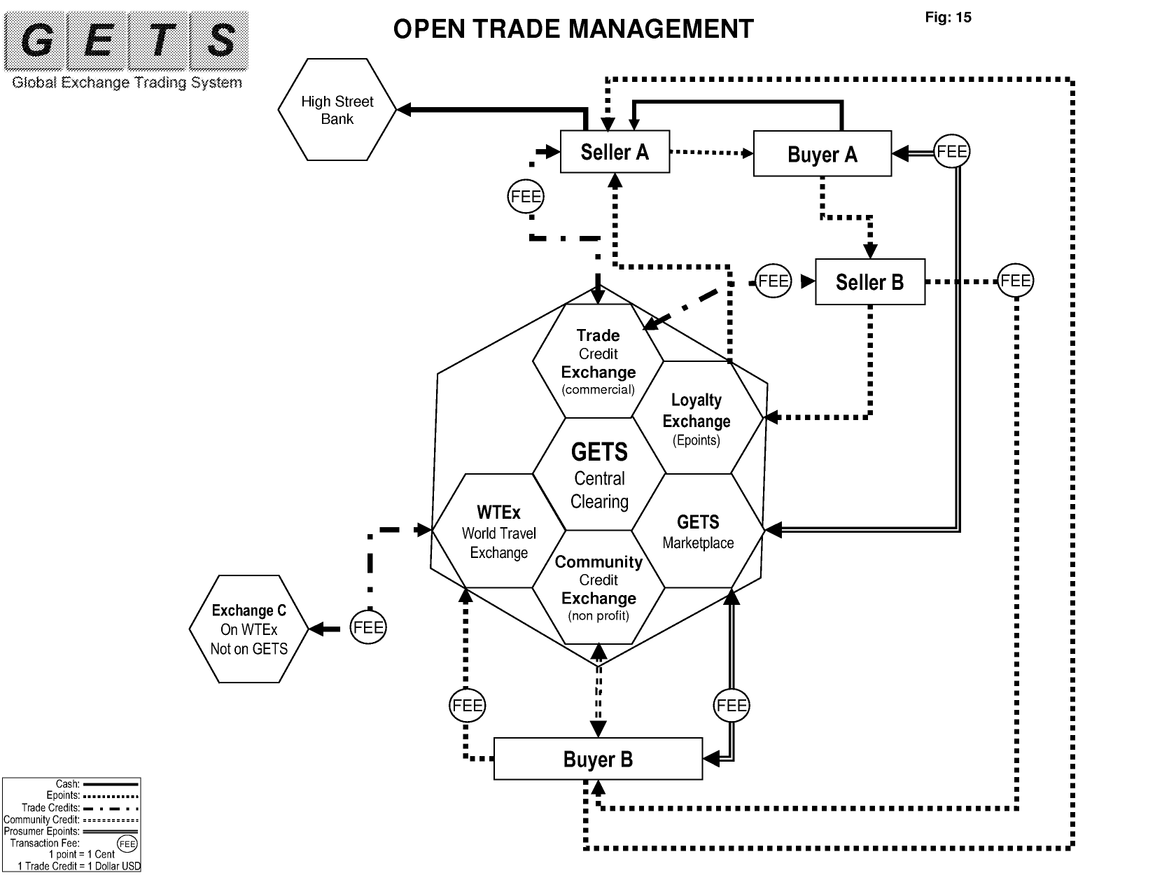

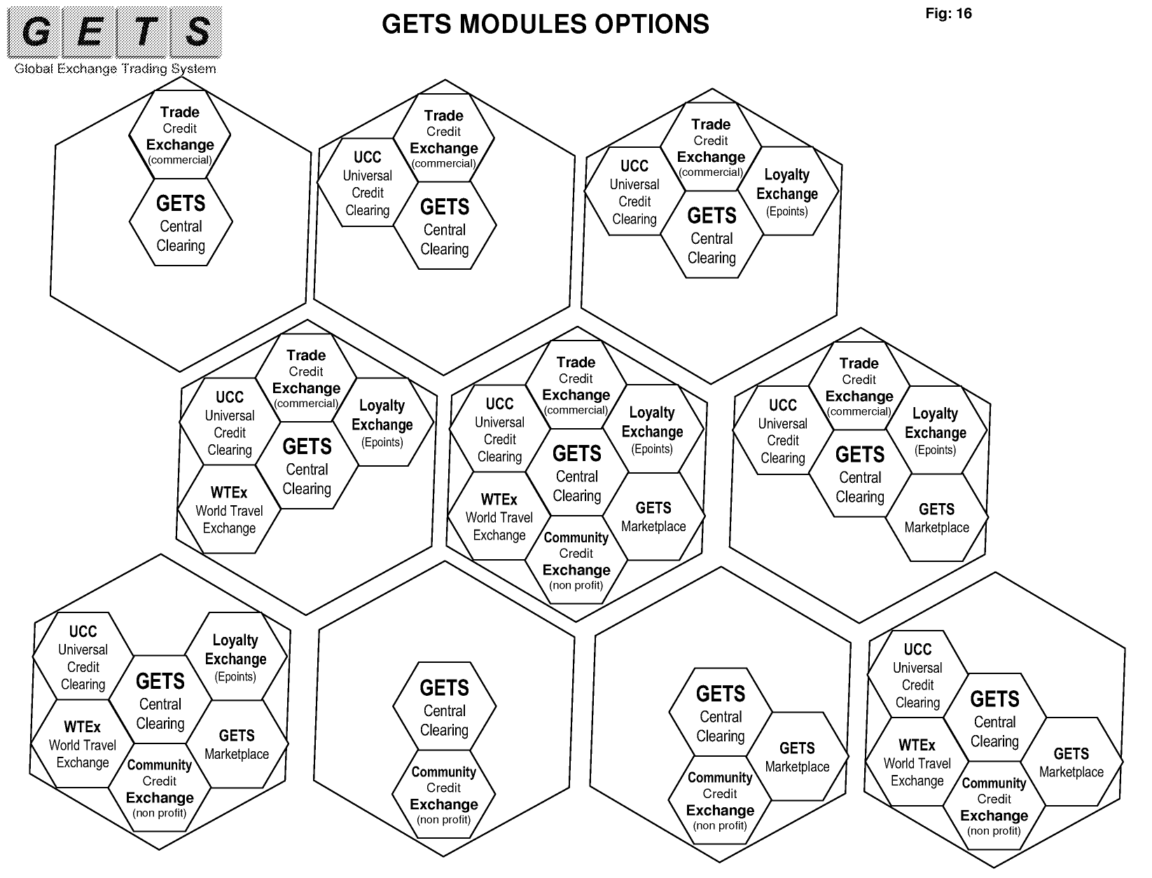

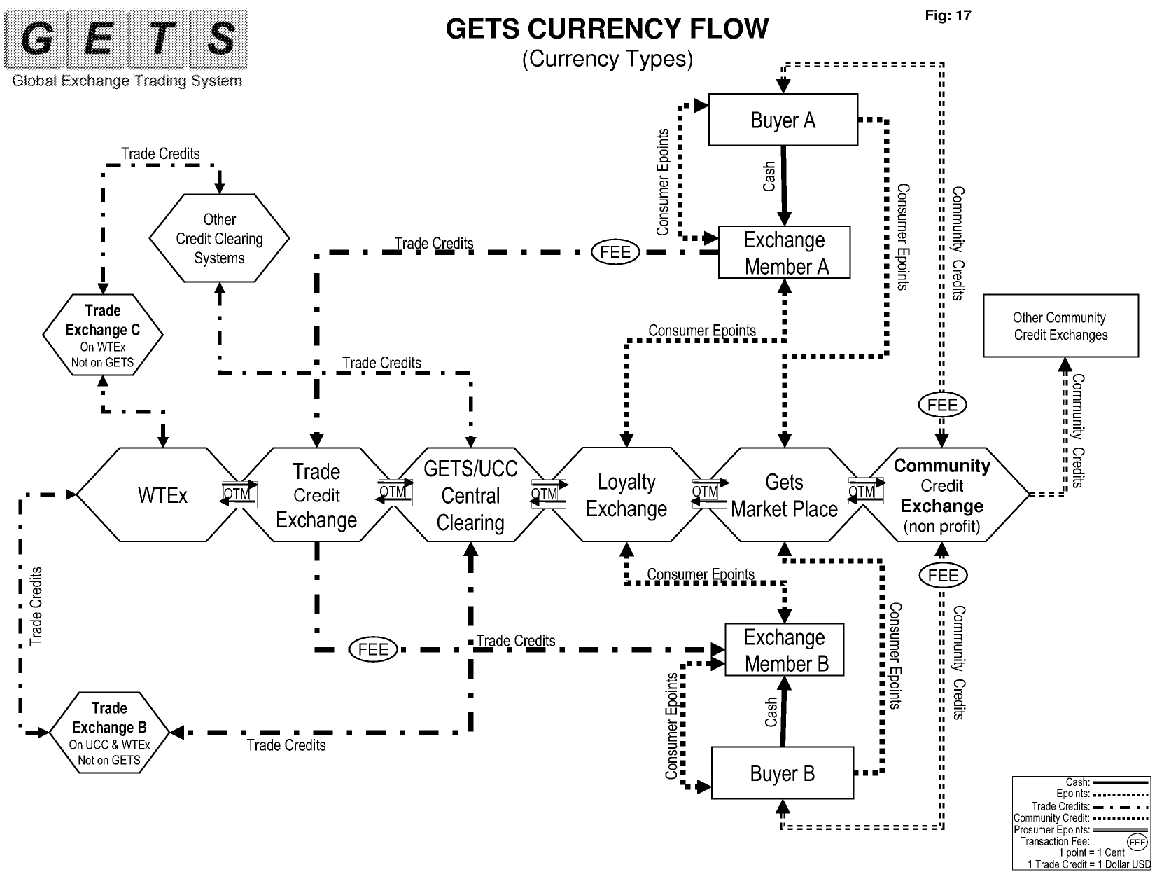

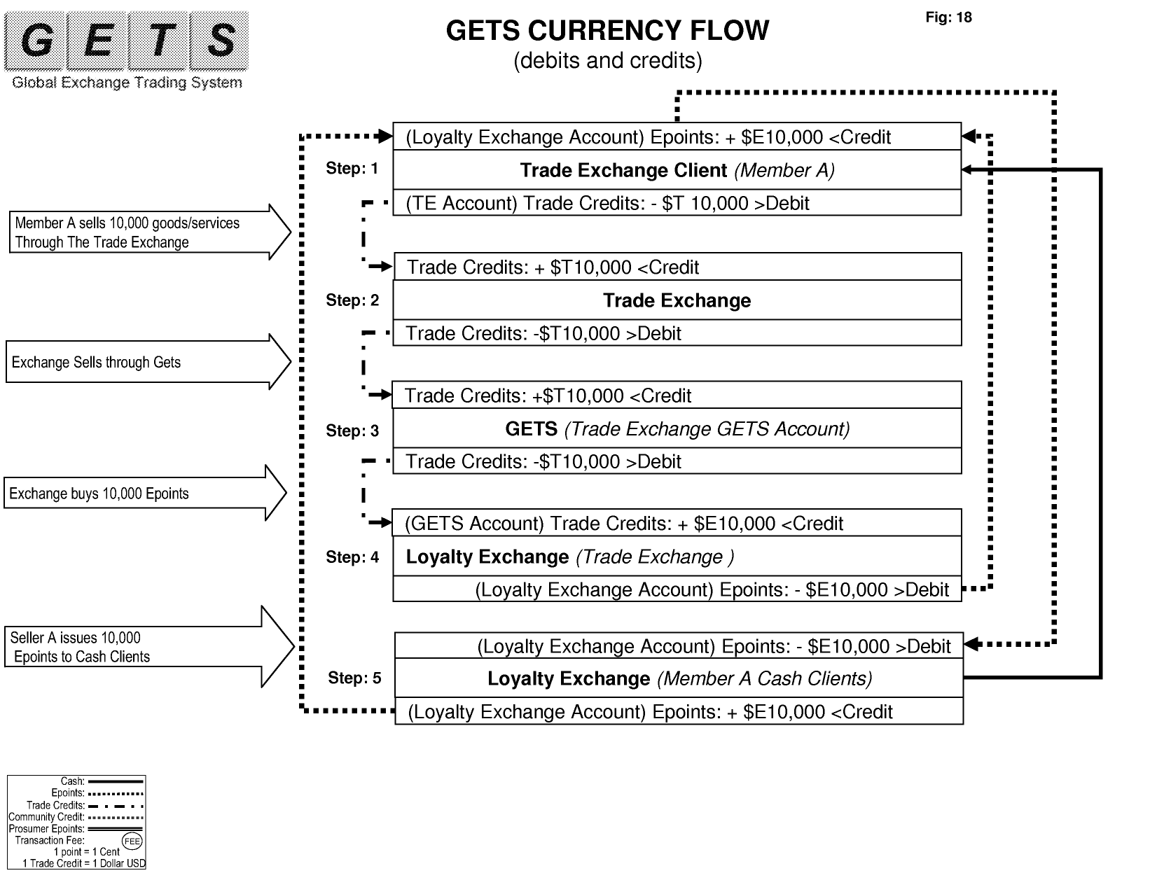

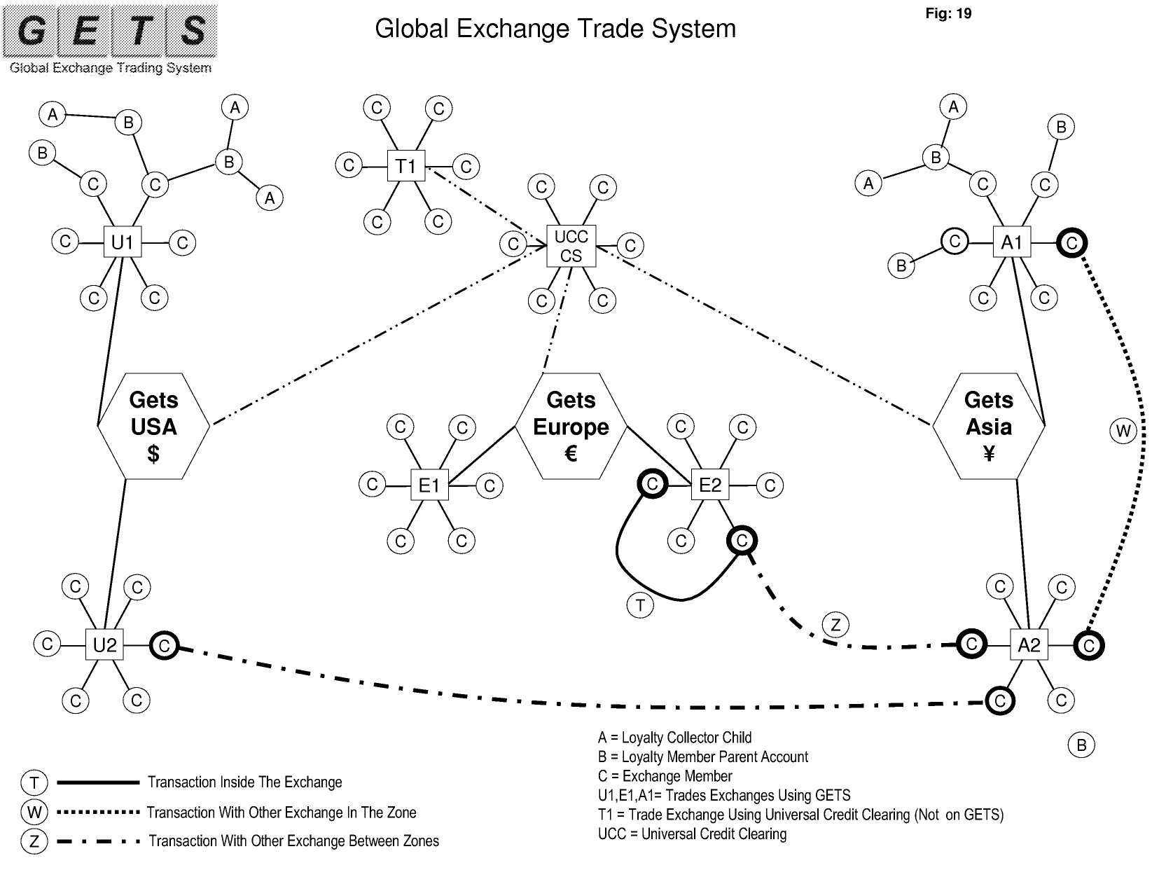

FIGS. 12 through 19 provide further description of a GTCES by generally providing further detail, illustrating some of the different relationships involving a GTCES and other entities or systems, and showing transactional flow through the system and related modules. For example, FIG. 12 illustrates an exemplary relationship among a GTCES, a multiple location loyalty exchange system and a Trade Credit Exchange as shown in FIG. 11, adding steps 8-0 illustrating the added participation of Cash Buyer B. FIGS. 13-15 are a series of three schematic diagrams depicting open trade management using a GTCES in which each successive figure illustrates the added participation of another module. FIG. 16 is a series of ten (10) schematic diagrams depicting alternative organizational arrangements using a GTCES to integrate the various formerly separate systems as described. FIGS. 17 and 18 are schematic diagrams depicting an exemplary flow of trade credits and debits among parties using a GTCES. FIG. 19 is a schematic diagram depicting the relationships among a number of universal currency systems (e.g. GETS USA $, GETS Europe £ and GETS Asia ¥) using a GTCES.

Without further elaboration, it is believed that one skilled in the art can, using the preceding description, utilize the present invention to its fullest extent. The preceding examples are offered by way of illustration and not by way of limiting the disclosure of the invention.

### OTHER EMBODIMENTS

When introducing elements of the present invention or the preferred embodiments thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense. Indeed, various modifications of the invention in addition to those shown and described herein will become apparent to those skilled in the art from the foregoing description which do not depart from the spirit or scope of the present inventive discovery. Such modifications are also intended to fall within the scope of the appended claims.

### References Cited

All publications, patents, patent applications and other references cited in this application are incorporated herein by reference in their entirety for all purposes to the same extent as if each individual publication, patent, patent application or other reference was specifically and individually indicated to be incorporated by reference in its entirety for all purposes. Citation of a reference herein shall not be construed as an admission that such is prior art to the present invention.

1. A method of rewarding a buyer for a purchase from a seller that is a member of a Trade Credit Exchange, said method comprising: the seller offering an amount of trade credit backed Epoints to a buyer of goods or services from the seller, the trade credit backed Epoints redeemable by the buyer for non-or part cash purchase of other goods and services in a Trade Credit Exchange; and the seller transferring the amount of trade credit backed Epoints to the buyer when the buyer completes a purchase of goods or services from the seller.

2. A method according to claim 1 wherein an accounting system of the Trade Credit Exchange records trade credit transactions between buyers and sellers of the exchange, the method further comprising: issuing an amount of trade credit backed Epoints to the seller, the amount of trade credit backed Epoints based upon a cash value of goods or services offered by the seller for non-or part cash purchase through the Trade Credit Exchange; the accounting system adding the amount of trade credit backed Epoints to an Epoint account uniquely associated with the buyer in the Trade Credit Exchange; and the accounting system accumulating the amount of trade credit backed Epoints in the Epoint account having a total Epoint amount, the Epoint account uniquely associated with the buyer.

3. A method according to claim 2 wherein the accounting system of the Trade Credit Exchange is an electronic accounting system in electronic communication with a plurality of electronic point-of-sale terminals.

4. A method according to claim 3 further comprising the accounting system providing access by the buyer to trade credit backed Epoints in the buyer's Epoints account for use in exchange for a good or service offered for purchase through a Trade Credit Exchange.

5. A method according to claim 3 wherein access to trade credit backed Epoints is provided by determining that the buyer has properly accessed the buyer's Epoint account, and decreasing the total Epoint amount in the buyer's Epoint account by a purchase price amount when the buyer uses the purchase price amount of trade credit backed Epoints for a purchase of a good or service through a Trade Credit Exchange or at point-of-sale.

6. A method according to claim 5 further comprising: assigning to each buyer a unique identifier associated with that buyer's Epoint account; when a buyer requests access to a buyer's Epoint account for a purchase, determining that the buyer is properly accessing the buyer's own account by requesting that the buyer input the unique identifier into a point-of-sale terminal.

7. A method of promoting reciprocal trade transactions comprising: a seller that is a member of at least one Trade Credit Exchange obtaining an amount of trade credit backed Epoints from the loyalty exchange's Epoint account, the amount of trade credit backed Epoints determined by a cash value of a good or a service offered by the seller for non-or part cash purchase through the Trade Credit Exchange; at a point-of-sale of a good or a service to a buyer, obtaining from said buyer a unique identifier; at a location of said seller, determining an amount of trade credit backed Epoints to provide to said buyer; for each said transaction, providing to an electronic exchange accounting system the buyer's unique identifier in association with the amount of Epoints; for each said transaction, determining an amount of trade credit backed Epoints based on the amount of trade credits; accumulating trade credits in an account in the accounting system that is associated with the buyer's unique identifier by adding the amount of trade credits to a total trade credit amount in the account; and providing the buyer associated with that buyer's unique identifier access to the total trade credit amount in the buyer's account for use for non-or part cash purchases through at least one Trade Credit Exchange.

8. A method according to claim 7 wherein the amount of trade credit backed Epoints to provide to said buyer is determined by applying a reward rule selected by said seller to the purchase amount of the transaction.

9. A method according to claim 8 wherein the reward rule comprises selecting a factor selected by said seller, and the amount of trade credit backed Epoints to provide to said buyer is determined by multiplying the factor by the purchase amount of the transaction.

10. A method according to claim 8 wherein the reward rule comprises selecting a minimum purchase price amount selected by said seller, and the amount of trade credit backed Epoints to provide to said buyer is determined by providing a fixed amount of trade credit backed Epoints to the buyer when the purchase price of the transaction meets or exceeds the minimum purchase amount selected by the seller.

11. The method of claim 10 wherein the amount of trade credit backed Epoints is calculated at the point-of-sale to the buyer merchant's and electronically transmitted to the electronic exchange accounting system.

12. An exchange accounting system for managing transactions between buyers and multiple sellers comprising: at multiple points-of-sale to buyers, an electronic data input element, said electronic data input element configured for buyers to enter: an alphanumeric identifier uniquely associated with the buyer in a point-of-sale transaction; and a monetary value of the point of-sale transaction; a first electronic memory element for storing a trade credit backed Epoints reward rule selected by the seller to the purchase amount of the point-of-sale transaction. a first processor for calculating an amount of trade credit backed Epoints based upon the monetary value of the point-of-sale transaction and application of the selected Epoints reward rule; at least one location remote from the points-of-sale locations, an electronic exchange accounting system configured to receive the buyer's unique identifier and amount of trade credit backed Epoints for each point-of-sale transaction with the buyer; an electronic communication element configured to communicate to the electronic exchange accounting system the buyer's unique identifier and amount of trade credit backed Epoints for each point-of-sale transaction with the buyer;
a second electronic memory element for storing accumulated loyalty points for a plurality of buyer accounts, each buyer account being associated respectively with a unique account identifier; a second processor configured to increment a total amount of trade credit backed Epoints in a buyer account associated with the buyer's unique identifier by the amount of Epoints associated with each point-of-sale transaction with the buyer; and electronic access element for providing to each buyer access to the total amount of trade credits or trade credit backed Epoints in the buyer account associated with that buyer's unique buyer identifier and unique account identifier.

13. An exchange accounting system according to claim 12, said second processor element further configured to decrease the total amount of trade credits or trade credit backed Epoints in each buyer account according to a transaction amount of trade credits or trade credit backed Epoints accessed by the buyer for a transaction.

14. An exchange accounting system according to claim 13, said electronic access element including a printer configured for imprinting a receipt with the transaction amount of trade credits or trade credit backed Epoints accessed by the buyer for the trade transaction.

15. An exchange accounting system according to claim 14, said printer further configured for to imprint the receipt with information identifying a good or service for which the buyer paid with the transaction amount of trade credits or trade credit backed Epoints accessed by the buyer for the trade transaction.

16. A method of allowing non-commercial entities to participate in a Trade Credit Exchange, said method comprising: maintaining a Trade Credit Exchange trade credit account and a loyalty exchange trade credit backed Epoints account; maintaining a trade credit account and a trade credit backed Epoints account for each member, exchanging trade credit backed Epoints of Trade Credit Exchange members for goods or services offered through the Trade Credits Exchange or through a Trade Credit Exchange network; and exchanging trade credits of members for goods or services offered through the Trade Credit Exchange or through a Trade Credit Exchange network.

17. A method according to claim 16 further comprising receiving trade credit backed Epoints from a Loyalty Exchange System.

18. A method for a Trade Credit Exchange to sell goods and services comprising using a GTCES for maintaining a plurality of trade credit accounts and a plurality of Epoints accounts using a GTCES; allowing members and users of the Trade Credit Exchaneg to purchase goods and services on the Trade Credit Exchange with trade credits or trade credit backed Epoints.

19. A computerized method of rewarding a buyer for a purchase from a seller that is a member of a Trade Credit Exchange conducted over a computer network, comprising: the seller offering to the buyer over the computer network an amount of trade credit backed Epoints on the Trade Credit Exchange, the trade credit backed Epoints redeemable over the computer network as at least partial payment for purchase of other goods or services offered by the Trade Credit Exchange over the computer network; the seller transferring over the amount of trade credit backed Epoints to the buyer when the buyer completes a purchase of goods or services from the seller.

20. A system capable of rewarding a buyer for a purchase from a seller that is a member of a Trade Credit Exchange conducted over a computer network, comprising: a computer device in communication with the computer network for conducting the Trade Credit Exchange comprising: a first processing portion configured to offer an amount of trade credit backed Epoints to the buyer from the seller in the Trade Credit Exchange, the trade credit backed Epoints redeemable over the computer network as at least partial payment for purchase of goods or services offered by the Trade Credit Exchange; a second processing portion configured to receive a trade of a good or a service over the computer network from the buyer in exchange for goods or services offered by the seller; a third processing portion configured to transfer the amount of trade credit backed Epoints to the buyer when the buyer completes the purchase of the seller's goods or services.

21. A system capable of rewarding a buyer for a purchase from a seller that is a member of a Trade Credit Exchange conducted over a computer network, comprising: a buyer's computer in communication with the computer network; a seller's computer in communication with the computer network; and a central computer device in communication with the computer network for conducting the Trade Credit Exchange, the central computer device being communicable with the buyer's computer and the seller's computer, the central computer device comprising: a first processing portion configured to receive a listing for a good or service for sale by the seller through the seller's computer and to list the seller's good or service on the Trade Credit Exchange; a second processing portion configured to receive a trade payment for the good or service through the Trade Credit Exchange over the computer network from the buyer through the buyer's computer; a third processing portion configured to receive an amount of trade credit backed Epoints from the seller through the seller's computer, the trade credit backed Epoints redeemable on the Trade Credit Exchange over the computer network as at least partial payment for purchase of goods or services offered by the Trade Credit Exchange; and a fourth processing portion configured to direct the amount of trade credit backed Epoints to the buyer.
